(19) United States
(12) Patent Application Publication
(10) Pub. No.: US 2022/0024415 A1
(43) Pub. Date: Jan. 27, 2022

(54) VEHICLE DOOR CONTROL METHOD, APPARATUS, AND STORAGE MEDIUM

(71) Applicant: SHANGHAI SENSETIME INTELLIGENT TECHNOLOGY CO., LTD., Shanghai (CN)

(72) Inventors: Yangping WU, Shanghai (CN); Qin XIAO, Shanghai (CN); Songya LOU, Shanghai (CN); Tong LI, Shanghai (CN); Chen QIAN, Shanghai (CN)

(21) Appl. No.: 17/489,686

(22) Filed: Sep. 29, 2021

Related U.S. Application Data
(63) Continuation of application No. PCT/CN2020/092601, filed on May 27, 2020.

(30) Foreign Application Priority Data
Oct. 22, 2019 (CN) 201911006853.5

(51) Int. Cl. B60R 25/30; G06K 9/00; B60R 25/01; B60R 25/25; B60R 25/31; E05F 15/73; E05F 15/76

(52) U.S. Cl. CPC B60R 25/305; E05Y 2900/531; G06K 9/00791; G06K 9/00369; G06K 9/00832; B60R 25/01; B60R 25/25; B60R 25/31; E05F 15/73; E05F 15/76; E05F 2015/767; E05Y 2400/45; E05Y 2400/85; E05Y 2900/546; G06K 9/00288

(57) ABSTRACT

The present application relates to a vehicle door control method, apparatus, and system, a vehicle, an electronic device, and a storage medium. The method comprises: controlling an image acquisition module disposed on a vehicle to acquire a video stream; performing face recognition on the basis of at least one image in the video stream to obtain a face recognition result; determining, on the basis of the face recognition result, control information corresponding to at least one vehicle door of the vehicle; if the control information comprises controlling any vehicle door of the vehicle to open, obtaining state information of the vehicle door; if the state information of the vehicle door is Not Unlocked, controlling the vehicle door to unlock and open; and/or, if the state information of the vehicle door is Unlocked And Unopened, controlling the vehicle door to open module.

### CROSS-REFERENCE TO RELATED APPLICATION

The present application is a continuation of and claims the priority under 35 U.S.C. § 120 to PCT Application No. PCT/CN2020/092601, filed on May 27, 2020, which claims the priority to Chinese Patent Application No. 201911006853.5 with China National Intellectual Property Administration, filed on Oct. 22, 2019, entitled “VEHICLE DOOR CONTROL METHOD, APPARATUS, AND SYSTEM, VEHICLE, ELECTRONIC DEVICE, AND STORAGE MEDIUM”. All the above referenced priority documents are incorporated herein by reference in their entireties.

### TECHNICAL FIELD

The present disclosure relates to the field of computer technology, and in particular to a vehicle door control method, an apparatus, a system, a vehicle, an electronic device and a storage medium.

### BACKGROUND

Currently, a user needs to control the vehicle door with a key (e.g., a mechanical key or a remote key). For the users, in particular for those who like sports, carrying the vehicle key has the problem of being inconvenient. Furthermore, the key has the risk of being damaged, malfunctioning or being lost.

### SUMMARY

The present disclosure provides a technical solution for vehicle door control.

According to one aspect of the present disclosure, a vehicle door control method is provided, comprising: controlling an image acquisition module provided in a vehicle to acquire a video stream; performing face recognition based on at least one image in the video stream to obtain a face recognition result; determining control information corresponding to at least one vehicle door of the vehicle based on the face recognition result; acquiring, if the control information includes controlling any one vehicle door of the vehicle to open, state information of the vehicle door; controlling the vehicle door to unlock and open if the state information of the vehicle door is not unlocked; and/or controlling the vehicle door to open if the state information of the vehicle door is unlocked and unopened.

According to one aspect of the present disclosure, a vehicle door control apparatus is provided, comprising: a processor; a memory configured to store processor-executable instructions; wherein the processor is configured to execute the foregoing vehicle door control method.

According to one aspect of the present disclosure, a computer-readable storage medium having stored computer program instructions thereon is provided, which implement, when executed by a processor, the foregoing vehicle door control method.

In an embodiment of the present disclosure, by controlling an image acquisition module provided in a vehicle to acquire a video stream; performing face recognition based on at least one image in the video stream to obtain a face recognition result; determining control information corresponding to at least one vehicle door of the vehicle based on the face recognition result; acquiring, if the control information includes controlling any one vehicle door of the vehicle to open, state information of the vehicle door; controlling the vehicle door to unlock and open if the state information of the vehicle door is not unlocked; and/or controlling the vehicle door to open if the state information of the vehicle door is unlocked and unopened, it is possible to enable the door to be opened automatically for the user based on the face recognition without the need of the user to manually pull open the door, thereby improving the convenience in using the vehicle.

It is understood that the foregoing general description and the subsequent detailed description are merely exemplary and illustrative, and are not intended to limit the present disclosure.

Additional features and aspects of the present disclosure will become apparent from the following description of exemplary examples with reference to the attached drawings.

### BRIEF DESCRIPTION OF THE DRAWINGS

The drawings, which are incorporated in and constitute part of the specification, together with the description, illustrate exemplary examples, features and aspects of the present disclosure and serve to explain the principles of the present disclosure.

FIG. 1 illustrates a flowchart of a vehicle door control method provided by an embodiment of the present disclosure.

FIG. 2 illustrates a schematic diagram of an attachment height and a recognizable height range of the image acquisition module in a vehicle door control method provided by an embodiment of the present disclosure.

FIG. 3a illustrates a schematic diagram of an image sensor and a depth sensor in a vehicle door control method provided by an embodiment of the present disclosure.

FIG. 3b illustrates a further schematic diagram of an image sensor and a depth sensor according to a vehicle door control method provided by an embodiment of the present disclosure.

FIG. 4 illustrates a schematic diagram of a vehicle door control method provided by an embodiment of the present disclosure.

FIG. 5 illustrates another schematic diagram of a vehicle door control method provided by the embodiment of the present disclosure.

FIG. 6 illustrates a schematic diagram of an example of a living body detection method according to an embodiment of the present disclosure.

FIG. 7 illustrates an exemplary schematic diagram of a depth map update in a vehicle door control method provided by an embodiment of the present disclosure.

FIG. 8 illustrates a schematic diagram of surrounding pixels in a vehicle door control method provided by an embodiment of the present disclosure.

FIG. 9 illustrates another schematic diagram of peripheral pixels in a vehicle door control method provided by an embodiment of the present disclosure.

FIG. 10 illustrates a block diagram of a vehicle door control apparatus according to an embodiment of the present disclosure.

FIG. 11 illustrates a block diagram of a vehicle door control system provided by an embodiment of the present disclosure.

FIG. 12 illustrates a schematic diagram of the vehicle door control system according to the embodiment of the present disclosure.

FIG. 13 illustrates a schematic diagram of a vehicle provided according to an embodiment of the present disclosure.

### DETAILED DESCRIPTION

Various exemplary examples, features and aspects of the present disclosure will be described in detail with reference to the drawings. The same reference numerals in the drawings represent parts having the same or similar functions. Although various aspects of the examples are shown in the drawings, it is unnecessary to proportionally draw the drawings unless otherwise specified.

Herein the term “exemplary” means “used as an instance or example, or explanatory”. An “exemplary” example given here is not necessarily construed as being superior to or better than other examples.

Herein the term “and/or” describes a relation between associated objects and indicates three possible relations. For example, the phrase “A and/or B” indicates a case where only A is present, a case where A and B are both present, and a case where only B is present. In addition, the term “at least one” herein indicates any one of a plurality or a random combination of at least two of a plurality. For example, including at least one of A, B and C means including any one or more elements selected from a group consisting of A, B and C.

Numerous details are given in the following examples for the purpose of better explaining the present disclosure. It should be understood by a person skilled in the art that the present disclosure can still be realized even without some of those details. In some of the examples, methods, means, units and circuits that are well known to a person skilled in the art are not described in detail so that the principle of the present disclosure become apparent.

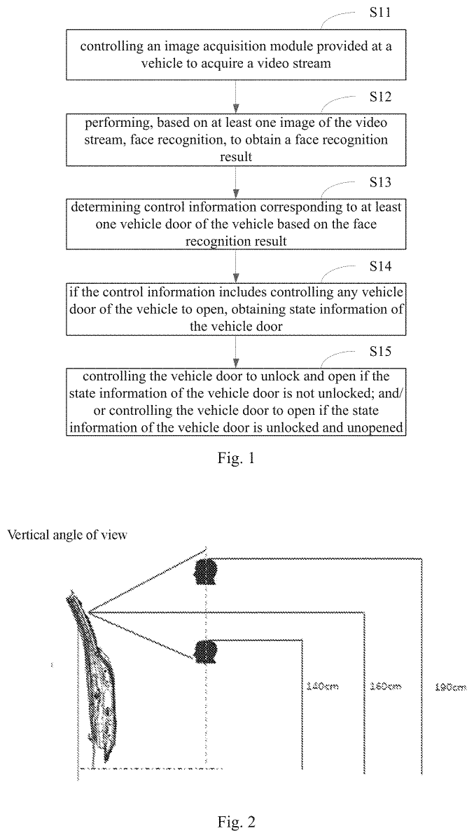

FIG. 1 illustrates a flowchart of a vehicle door control method provided in an embodiment of the present disclosure. In one possible implementation of the present disclosure, the execution body of the vehicle door control method may be a vehicle door control apparatus; or, the vehicle door control method may be executed by on-board device or other processing device. Alternatively, the vehicle door control method may be implemented by a processor executing computer-readable instructions stored in a memory. As shown in FIG. 1, the vehicle door control method includes step S11 to step S15.

In step S11, controlling an image acquisition module provided in a vehicle to acquire a video stream

In one possible implementation, the controlling an image acquisition module provided in a vehicle to acquire a video stream comprises: controlling the image acquisition module provided on an outdoor portion of the vehicle to acquire a video stream outside the vehicle. In this implementation, the image acquisition module may be attached to the outdoor portion of the vehicle and acquire the video stream outside the vehicle by controlling the image acquisition module provided on the outdoor portion of the vehicle, whereby it is possible to detect a boarding intention of a person outside the vehicle based on the video stream outside the vehicle.

In one possible implementation, the image acquisition module may be attached in at least one position of: B pillar of the vehicle, at least one vehicle door, and at least one rear-view mirror. The vehicle door according to the embodiment of the present disclosure may include a vehicle door for occupants (e.g., a left front door, a right front door, a left rear door, or a right rear door) and may also include a tail gate of the vehicle, etc. For example, the image acquisition module may be attached in a position of the B pillar which is in a range from 130 cm to 160 cm from the ground; a horizontal recognition distance of the image acquisition module may be 30 cm to 100 cm, which is not limited herein. FIG. 2 illustrates a schematic diagram of an attachment height and a recognizable height range of the image acquisition module in a vehicle door control method provided by an embodiment of the present disclosure. In the example shown in FIG. 2, the attachment height of the image acquisition module is 160 cm; and the recognizable height is in a range from 140 cm to 190 cm.

In an example, the image acquisition module may be attached to two B pillars and a trunk of the vehicle. For example, at least one B pillar may have an image acquisition module oriented toward a boarding position of an occupant in the front row (a driver or a co-driver) and an image acquisition module oriented toward a boarding position of an occupant in the rear row.

In one possible implementation, the controlling the image acquisition module provided in the vehicle to acquire the video stream comprises: controlling the image acquisition module provided in an indoor portion of the vehicle to acquire a video stream inside the vehicle. In this implementation, the image acquisition module may be attached to the indoor portion of the vehicle, so that it is possible to detect a disembarking intention of a person inside the vehicle based on the video stream inside the vehicle by controlling the image acquisition module provided in the indoor portion of the vehicle to acquire the video stream inside the vehicle.

As one example of this implementation, the controlling the image acquisition module provided in the indoor portion of the vehicle to acquire the video stream inside the vehicle comprises: controlling an image acquisition module provided in an indoor portion of the vehicle to acquire a video stream inside the vehicle in a case where a driving speed of the vehicle is 0 and there is an occupant in the vehicle. In this example, by controlling the image acquisition module provided in the indoor portion of the vehicle to acquire the video stream inside the vehicle in a case where the driving speed of the vehicle is 0 and there is the occupant in the vehicle, it is possible to ensure safety while saving power consumption.

In step S12, performing face recognition based on at least one image in the video stream, to obtain a face recognition result

For example, the face recognition may be performed based on the first image in the video stream to obtain the face recognition result. The first image may contain at least a portion of a body or a face. The first image may be an image selected from the video stream. An image may be selected from the video stream with various methods. In a specific example, the first image is an image selected from the video stream satisfying a predetermined quality condition. The predetermined quality condition may include any one or any combination of: whether or not containing the body or the face, whether or not the body or face is located in a central area of the image, whether or not the body or face is completely contained in the image, a proportion of the body or face in the image, a status of the body or face (e.g., orientation of the body, angle of the face), image resolution, image exposure, etc., which is not limited in the embodiment.

In one possible implementation, the face recognition includes face authentication. The performing face recognition based on at least one image in the video stream comprises: performing face authentication based on the first image in the video stream and pre-registered facial features. In this implementation, the face authentication is to extract facial features in the acquired image, compare the facial features in the acquired image with the pre-registered facial features to determine whether or not they are facial features of the same person. For example, it may be determined whether or not the facial features in the acquired image are the facial features which belong to an owner or a temporary user (e.g., a friend of the owner or a courier).

In one possible implementation, the face recognition further includes living body detection. The performing the face recognition based on at least one image in the video stream comprises: acquiring a first depth map corresponding to the first image in the video stream via a depth sensor in the image acquisition module; and performing the living body detection based on the first image and the first depth map. In this implementation, the living body detection is to verify whether or not there is a living body. For example, it may be configured to verify whether there is a body.

In an example, the living body detection is performed before the face authentication. For example, if the living body detection result for the person is that the person is a living body, the face authentication process will be triggered; if the living body detection result for the person is that the person is a false body, the face authentication process will not be triggered.

In a further example, the face authentication is performed before the living body detection. For example, if the face authentication is successful, the living body detection process will be triggered; if the face authentication is unsuccessful, the living body detection will not be triggered.

In a further example, the living body detection and the face authentication are performed simultaneously.

In an embodiment of the present disclosure, the depth sensor refers to a sensor configured to acquire depth information. The embodiment of the present disclosure does not limit the operating principle and operating band of the depth sensor.

In the embodiment of the present disclosure, the image sensor and the depth sensor of the image acquisition module are provided individually or provided integrally. For example, the image sensor and the depth sensor of the image acquisition module may be configured individually using an RGB(Red; Green; Blue) sensor or an infrared sensor as the image sensor and a binocular infrared sensor or a TOF (Time of Flight) sensor as the depth sensor. Integral configuration of the image sensor and the depth sensor of the image acquisition module may be implemented by an image acquisition module using an RGBD (Red; Green; Blue; Deep) sensor to realize functions of an image sensor and a depth sensor.

As an example, the image sensor is an RGB sensor. If the image sensor is the RGB sensor, images acquired by the image sensor are RGB images.

As another example, the image sensor is an infrared sensor. If the image sensor is the infrared sensor, images acquired by the image sensor are infrared images. The infrared image may be an infrared image with spots or without spots.

In other examples, the image sensor may be other type of a sensor, which is not limited herein.

As an example, the depth sensor is a three-dimensional sensor. For example, the depth sensor may be a binocular infrared sensor, a Time of Flight TOF sensor or a structured light sensor. The binocular infrared sensor includes two infrared cameras. The structured light sensor may be an encoded structured light sensor or a scattered structured light sensor. By acquiring a depth map of a person with the depth sensor, it is possible to acquire a depth map with high precision. The embodiment of the present disclosure uses a depth map containing a face to perform the living body detection, whereby it is possible to sufficiently exploit depth information of the face, so as to enable improvement in accuracy of the living body detection.

In an example, the TOF sensor uses a TOF module based on an infrared band. In this example, by using the TOF module based on the infrared band, it is possible to reduce the influence of ambient light on the capturing of the depth map.

In the embodiment of the present disclosure, the first depth map may correspond to the first image. For example, the first depth map and the first image may be respectively acquired by the depth sensor and the image sensor for the same scenario; or the first depth map and the first image may be respectively acquired by the depth sensor and the image sensor for the same target area at the same timing, which is not limited hereto.

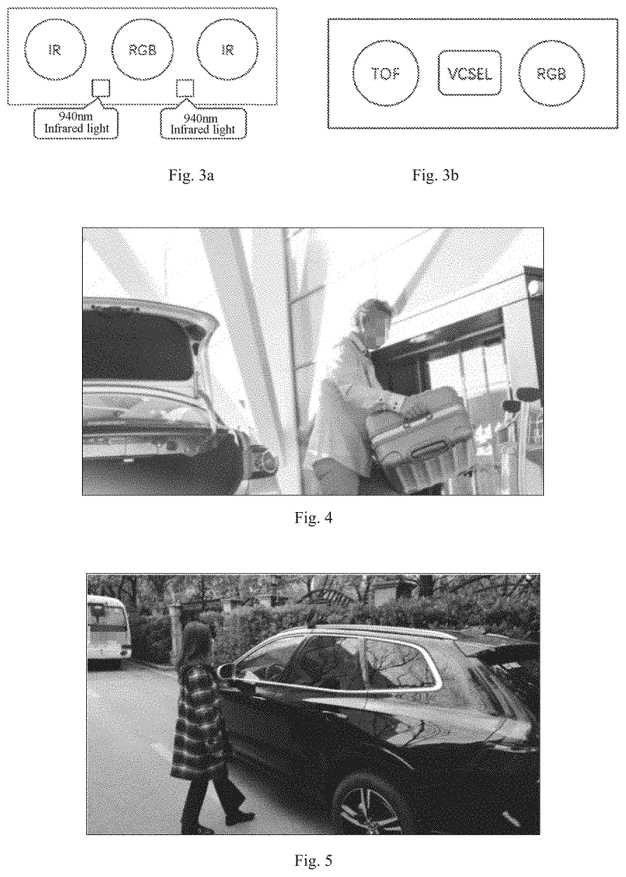

FIG. 3a illustrates a schematic diagram of an image sensor and a depth sensor in a vehicle door control method provided by an embodiment of the present disclosure. In the example shown in FIG. 3a, the image sensor is an RGB sensor, the camera of the image sensor is an RGB camera, the depth sensor is a binocular infrared sensor, the depth sensor includes two infrared (IR) cameras, and the two infrared cameras of the binocular infrared sensor are provided on two sides of the RGB camera of the image sensor, where the two infrared cameras acquires depth information based on the binocular parallax principle.

In an example, the image acquisition module further comprises at least one fill light, the at least one fill light being provided between the infrared camera of the binocular infrared sensor and the camera of the image sensor, the at least one fill light including at least one of a fill light for the image sensor and a fill light for a depth sensor. For example, if the image sensor is an RGB sensor, the fill light for the image sensor may be a white light; if the image sensor is an infrared sensor, the fill light for the image sensor may be an infrared light; if the depth sensor is a binocular infrared sensor, the fill light for the depth sensor may be an infrared light. In the example shown in FIG. 3a, an infrared light is provided between the infrared camera of the binocular infrared sensor and the camera of the image sensor. For example, the infrared light may use an infrared ray of 940 nm.

In an example, the fill light may be in a normally on mode. In this example, when the camera of the image acquisition module is in an operating state, the fill light may be in an on mode.

In a further example, the fill light may be turned on when there is insufficient light. For example, an ambient light sensor may be used to acquire an ambient light intensity, determine insufficient light when the ambient light intensity is below a light intensity threshold, and turn on the fill light.

FIG. 3b illustrates a further schematic diagram of the image sensor and the depth sensor according to a vehicle door control method provided by an embodiment of the present disclosure. In the example shown in FIG. 3b, the image sensor is an RGB sensor, the camera of the image sensor is an RGB camera, and the depth sensor is a TOF sensor.

In an example, the image acquisition module further comprises a laser disposed between the camera of the depth sensor and the camera of the image sensor. For example, the laser is disposed between the camera of the TOF sensor and the camera of the RGB sensor. For example, the laser may be VCSEL (Vertical Cavity Surface Emitting Laser); and the TOF sensor may be capable of acquiring a depth map based on laser emitted by the VCSEL.

In the embodiment of the present disclosure, the depth sensor is configured to acquire a depth map, and the image sensor is configured to acquire a two-dimensional image. Please note that, although the image sensor is illustrated with RGB sensor and infrared sensor as examples, and the depth sensor is illustrated with binocular infrared sensor, TOF sensor, and structured light sensor as examples, a person skilled in the art would understand that the embodiment of the present disclosure is not limited hereto. A person skilled in the art may choose the type of image sensor and depth sensor according to actual application requirements, as long as they are capable of acquiring 2D images and depth maps, respectively.

In one possible implementation, the face recognition further includes permission authentication. The performing the face recognition based on at least one image in the video stream comprises: acquiring, based on a first image in the video stream, door-opening permission information of a person; performing permission authentication based on the door-opening permission information of the person. According to this implementation, it is possible to set different door-opening permission information for different users, whereby it is possible to improve the security of the vehicle.

As one example of this implementation, the door-opening permission information of the person includes one or more of: information of a vehicle door over which the person has door-opening permission, a time when the person has door-opening permission, or a number of times of door-opening permission corresponding to the person.

For example, the information of a vehicle door over which the person has door-opening permission may be all vehicle doors or the tail gate. For example, the vehicle door over which the owner or a family or friend of the owner has door-opening permission may include all vehicle doors, while the vehicle door over which a courier or property management staff has door-opening permission may be the tail gate, wherein the owner may be capable of setting information of a vehicle door over which other people have door-opening permission.

For example, the time when a person has door-opening permission may be all time or a predetermined time period. For example, the time when the owner or a family or friend of the owner has door-opening permission may be all time. The owner may set the time when other people have door-opening permission. For example, in an application scenario where a friend of the owner borrows the vehicle from the owner, the owner may set the time when the friend has door-opening permission as two days. For a further example, when receiving a call from the courier, the owner may set a time when the courier has door-opening permission as a period between 13:00 and 14:00 on Sep. 29, 2019.

For example, the number of times of door-opening permission corresponding to a person may be an unlimited number of times or a limited number of times. For example, the number of times of door-opening permission corresponding to the owner or a family or friend of the owner may be an unlimited number of times. For a further example, the number of times of door-opening permission corresponding to a courier may be a limited number of times, such as once.

In step S13, determining control information corresponding to at least one vehicle door of the vehicle based on the face recognition result.

In one possible implementation, before determining control information corresponding to at least one vehicle door of the vehicle based on the face recognition result, the method further comprises determining door-opening intention information based on the video stream. The determining control information corresponding to at least one vehicle door of the vehicle based on the face recognition result comprising: determining control information corresponding to at least one vehicle door of the vehicle based on the face recognition result and the door-opening intention information.

In one possible implementation, the door-opening intention information may be intending to open door or not intending to open door. In particular, the intending to open door may be intending to board, intending to disembark, intending to place an item into the trunk or intending to take an item out of the trunk. For example, in a case where the video stream is acquired by the image acquisition module on the B pillar, if the door-opening intention information is intending to open door, it means that the person intends to board or intends to place an item; if the door-opening intention information is not intending to open door, it means that the person has no intention to board and has no intention to place an item. In a case where the video stream is acquired by image acquisition module on the tail gate, if the door-opening intention information is intending to open door, it means that the person intends to place items (e.g., luggage) into the trunk; if the door-opening intention information is not intending to open door, it means that the person has no intention to place an item into the trunk.

In one possible implementation, it is possible to determine the door-opening intention information based on a plurality of frames in the video stream, thereby improving the accuracy of the determined door-opening intention information.

As one example of this implementation, the determining door-opening intention information based on the video stream comprises: determining an Intersection-over-Union (IoU) of images of adjacent frames in the video stream; determining door-opening intention information based on the intersection-over-union of images of adjacent frames.

In an example, the determining the intersection-over-union of images of adjacent frames in the video stream may include: determining an intersection-over-union of bounding boxes of body in images of adjacent frames as the intersection-over-union of images of adjacent frames.

In a further example, the determining an intersection-over-union of images of adjacent frames in the video stream may include: determining an intersection-over-union of bounding boxes of face in images of adjacent frames as the intersection-over-union of images of adjacent frames.

In an example, the determining door-opening intention information based on the intersection-over-union of images of adjacent frames may include: caching intersection-over-union of images of latest acquired N groups of adjacent frames, wherein N is an integer greater than 1; determining a mean value of cached intersection-over-union; if a time during which the mean value is greater than a first predetermined value reaches a first predetermined time length, the door-opening intention information is determined as intending to open door. For example, N is 10, the first predetermined value is 0.93, or the first predetermined time length is 1.5 seconds. Certainly, the specific values of N, the first predetermined value and first predetermined time length may be set flexibly according to the actual application scenario. In this example, the N intersection-over-union that are cached are IoUs of images of latest acquired N groups of adjacent frames. When new images are acquired, an earliest intersection-over-union in the cache is removed, and the intersection-over-union between the latest acquired image and a previous image is stored in the cache. Throughout the present application, “cache” is intended to refer generally to any storage, buffer, or the like which can be used to temporarily store data. Person skilled in the art would understand that “caching” and “cached” shall be interpreted accordingly in a broad sense.

For example, N is 3, the latest acquired four images are Image 1, Image 2, Image 3 and Image 4, wherein Image 4 is the latest acquired image. In that case, the cached intersection-over-unions include an intersection-over-union 112 between Image 1 and Image 2, an intersection-over-union 123 between Image 2 and Image 3, and an intersection-over-union 134 between Image 3 and Image 4; the mean value of the cached intersection-over-unions is the mean value among the 112, 123, and 134. If the mean value among the 112, 123 and 134 is greater than the first predetermined value, a further Image 5 is acquired by the image acquisition module, and the intersection-over-union 112 is removed, an intersection-over-union 145 between Image 4 and Image 5 is cached; thus, the mean value of the cached intersection-over-unions is the mean value among the 123, 134 and 145. If the time during which the mean value of cached intersection-over-unions is greater than the first predetermined value reaches the first predetermined time length, the door-opening intention information is determined as intending to open door; otherwise, the door-opening intention information may be determined as not intending to open door.

In a further example, the determining the door-opening intention information based on the intersection-over-union of images of adjacent frames may include: if a number of consecutive groups of adjacent frames of which the intersection-over-union is greater than the first predetermined value is larger than a second predetermined value, the door-opening intention information is determined as intending to open door.

In the above example, by determining the intersection-over-union of images of adjacent frames in the video stream and determining the door-opening intention information based on the intersection-over-union of images of adjacent frames, it is possible to accurately determine the door-opening intention of a person.

As another example of the implementation, the determining door-opening intention information based on the video stream comprises: determining an area of a body region in latest acquired multi-frame images in the video stream; determining the door-opening intention information according to the area of the body region in the latest acquired multi-frame images.

In an example, the determining the door-opening intention information according to the area of the body region in the latest acquired multi-frame images may include: if the area of the body region in all of the latest acquired multi-frame images is greater than a first predetermined area, determining the door-opening intention information as intending to open door.

In a further example, the determining the door-opening intention information according to the area of the body region in the latest acquired multi-frame images may include: if the area of the body region in the latest acquired multi-frame images increases gradually, determining the door-opening intention information as intending to open door. The area of the body region in the latest acquired multi-frame images increasing gradually may indicate that the area of the body region in the image of which the time of acquisition is closer to a current time is larger than the area of the body region in the image of which the time of acquisition is further from the current time; or the area of the body region in the image of which the time of acquisition is closer to a current time is larger than or equal to the area of the body region in the image of which the time of acquisition is further from the current time.

In the above example, by determining an area of a body region in latest acquired multi-frame images in the video stream and determining the door-opening intention information according to the area of the body region in the latest acquired multi-frame images, it is possible to accurately determine the door-opening intention of a person.

As another example of the implementation, the determining door-opening intention information based on the video stream comprises: determining an area of a face area in latest acquired multi-frame images in the video stream; and determining the door-opening intention information based on the area of the face area in the latest acquired multi-frame images.

In an example, the determining the door-opening intention information based on the area of the face area in the latest acquired multi-frame images may include: if the area of the face area in all of the latest acquired multi-frame images is greater than a second predetermined area, determining the door-opening intention information as intending to open door.

In a further example, the determining the door-opening intention information based on the area of the face area in the latest acquired multi-frame images may include: if the area of the face area in the latest acquired multi-frame images increases gradually, determining the door-opening intention information as intending to open door. The area of the face area in the latest acquired multi-frame images increasing gradually may indicate that the area of the face area in the image of which the time of acquisition is closer to a current time is larger than the area of the face area in the image of which the time of acquisition is further from the current time; or the area of the face area in the image of which the time of acquisition is closer to a current time is larger than or equal to the area of the face area in the image of which the time of acquisition is further from the current time.

In the above example, by determining an area of a face area in latest acquired multi-frame images in the video stream and determining the door-opening intention information based on the area of the face area in latest acquired multi-frame images, it is possible to accurately determine the door-opening intention of a person.

In the embodiment of the present disclosure, by controlling at least one vehicle door of the vehicle based on the door-opening intention information, it is possible to reduce the possibility that the vehicle door-opens in a case where the user does not intend to open the door, thereby improving the safety of the vehicle.

In one possible implementation, the determining control information corresponding to at least one vehicle door of the vehicle based on the face recognition result and the door-opening intention information, comprising: if the face recognition result is face recognition successful, and the door-opening intention information is intending to open door, determining that the control information includes controlling at least one vehicle door of the vehicle to open.

In one possible implementation, before determining control information corresponding to at least one vehicle door of the vehicle based on the face recognition result, the method further comprises: performing object detection on at least one image of the video stream to determine the person's object carrying information. The determining the control information corresponding to at least one vehicle door of the vehicle based on the face recognition result comprises: determining the control information corresponding to at least one vehicle door of the vehicle based on the face recognition result and the person's object carrying information. In this implementation, it is possible to perform the vehicle door control based on the face recognition result and the person's object carrying information, without considering the door-opening intention information.

As one example of this implementation, the determining the control information corresponding to at least one vehicle door of the vehicle based on the face recognition result and the person's object carrying information, comprising: if the face recognition result is face recognition successful, and the person's object carrying information is the person carrying an object, determining that the control information includes controlling at least one vehicle door of the vehicle to open. According to this example, when the face recognition result is face recognition successful, and the person's object carrying information is the person carrying an object, it is possible to automatically open the vehicle door for the user, without the need of the user to open the vehicle door manually.

As one example of this implementation, the determining the control information corresponding to at least one vehicle door of the vehicle based on the face recognition result and the person's object carrying information, comprising: if the face recognition result is face recognition successful, and the person's object carrying information is the person carrying an object of a predetermined type, determining that the control information includes controlling a tail gate of the vehicle to open. According to this example, when the face recognition result is face recognition successful, and the person's object carrying information is the person carrying an object of a predetermined type, it is possible to automatically open the tail gate for the user, thereby eliminating the need of the user to open the tail gate manually when the person carries an object of the predetermined type.

In one possible implementation, before determining control information corresponding to at least one vehicle door of the vehicle based on the face recognition result, the method further comprises: performing object detection on at least one image of the video stream to determine the person's object carrying information. The determining control information corresponding to at least one vehicle door of the vehicle based on the face recognition result and the door-opening intention information comprises: determining control information corresponding to at least one vehicle door of the vehicle based on the face recognition result, the door-opening intention information, and the person's object carrying information.

In this implementation, the person's object carrying information may be information about the object carried by the person. For example, the person's object carrying information may indicate whether or not the person carries an object. For another example, the person's object carrying information may indicate the type of the object carried by the person.

According to this implementation, when the user has difficulty in opening vehicle door (e.g., when the user carries an item, such as a handbag, a shopping bag, a trolley case, an umbrella, etc.), the vehicle door (e.g., the left front door, the right front door, the left rear door, the right rear door, the tail gate) is automatically popped open for the user, thus greatly facilitating the user to get into the vehicle and place an item into the trunk in scenarios where the user is carrying an item or it is raining, for example. With this implementation, the face recognition process is automatically triggered when the user approaches the vehicle, without deliberate actions (such as touching a button or making a gesture), whereby the vehicle door is opened automatically for the user without the user having to free a hand to unlock or open the door, thereby improving the user's experience of boarding and placing items into the trunk.

As one example of this implementation, the determining control information corresponding to at least one vehicle door of the vehicle based on the face recognition result, the door-opening intention information, and the person's object carrying information, comprising: if the face recognition result is face recognition successful, the door-opening intention information is intending to open door, and the person's object carrying information is the person carrying an object, it is determined that the control information includes controlling at least one vehicle door of the vehicle to open.

In this example, if the person's object carrying information is that the person carries an object, it is determined that the person is having difficulty in manually pull open the vehicle door, for example, the person is carrying a heavy object or is holding an umbrella, and the like.

As one example of this implementation, the performing object detection on at least one image of the video stream, determining the person's object carrying information comprises: performing object detection on at least one image of the video stream to obtain the object detection result; determining the person's object carrying information based on the object detection result. For example, the object detection may be performed on the first image in the video stream to obtain the object detection result.

In this example, by performing object detection on at least one image of the video stream to obtain the object detection result and determining the person's object carrying information based on the object detection result, it is possible to accurately obtain the person's object carrying information.

In this example, the object detection result may be used as the person's object carrying information. For example, in a case where the object detection result includes an umbrella, the person's object carrying information includes the umbrella. For a further example, in a case where the object detection result includes an umbrella and a trolley case, the person's object carrying information includes the umbrella and the trolley case. For a further example, in a case where the object detection result is empty, the person's object carrying information may be empty.

In this example, an object detection network may be employed to perform object detection on at least one image in the video stream, wherein the object detection network may be based on a deep learning architecture. In this example, the types of objects that are recognizable by the object detection network may not be limited, and a person skilled in the art may flexibly set the types of objects that are recognizable by the object detection network according to the needs of the actual application scenario. For example, the types of objects recognizable by the object detection network include umbrella, trolley case, stroller, baby carriage, handbag, shopping bag, etc. By using an object detection network to perform object detection on at least one image in the video stream, it is possible to improve the accuracy and the speed of object detection

In this example, the performing object detection on at least one image of the video stream to obtain the object detection result may include: detecting a bounding box of a body in at least one image of the video stream; performing object detection on an area corresponding to the bounding box to obtain the object detection result. For example, a bounding box of a body in a first image of the video stream may be detected; and object detection is performed on a region corresponding to the bounding box in the first image. The region corresponding to the bounding box may indicate a region defined by the bounding box. In this example, by detecting a bounding box of a body in at least one image of the video stream and performing object detection on a region corresponding to the bounding box, it is possible to reduce the probability of interference of the background portion of the image in the video stream with the object detection, thereby improving the accuracy of the object detection.

In this example, the determining the person's object carrying information based on the object detection result may include: if the object detection result is that an object is detected, obtaining a distance between the object and a hand of the person; and determining the person's object carrying information based on the distance.

In an example, if the distance is less than a predetermined distance, it may be determined that the person's object carrying information is the person carrying an object. In this example, in determining the person's object carrying information, only the distance between the object and the hand of the person is considered, regardless of the dimension of the object.

In a further example, the determining the person's object carrying information based on the object detection result may further include: obtaining a dimension of the object if the object detection result is that an object is detected. The determining the person's object carrying information based on the distance comprises: determining the person's object carrying information based on the distance and the dimension. In this example, in determining the person's object carrying information, both the distance between the object and the hand of the person and the dimension of the object are taken into consideration.

The determining the person's object carrying information based on the distance and the dimension may include: determining the person's object carrying information as the person carrying an object if the distance is less than or equal to a predetermined distance and the dimension is greater than or equal to a predetermined dimension.

In this example, the predetermined distance may be 0; or the predetermined distance may be set to be greater than 0.

In this example, the determining the person's object carrying information based on the object detection result may include: obtaining a dimension of the object if the object detection result is that an object is detected; determining the person's object carrying information based on the dimension. In this example, in determining the person's object carrying information, only the dimension of the object is considered, regardless of the distance between the object and the hand of the person. For example, if the dimension is greater than the predetermined dimension, it is determined that the person's object carrying information is the person carrying an object.

As one example of this implementation, the determining the control information corresponding to at least one vehicle door of the vehicle based on the face recognition result, the door-opening intention information, and the person's object carrying information, comprising: determining that the control information includes controlling the tail gate of the vehicle to open if the face recognition result is face recognition successful, the door-opening intention information is intending to open door, and the person's object carrying information is the person carrying an object of a predetermined type. The predetermined type may indicate the type of object suitable to be placed into the trunk. For example, the present type may include, for example, a trolley case. FIG. 4 illustrates a schematic diagram of a vehicle door control method provided by an embodiment of the present disclosure. In the example shown in FIG. 4, if the face recognition result is face recognition successful, the door-opening intention information is intending to open door, and the person's object carrying information is the person carrying an object of a predetermined type (e.g., a trolley case), it is determined that the control information includes controlling the tail gate of the vehicle to open. In this example, by determining that the control information includes controlling the tail gate of the vehicle to open if the face recognition result is face recognition successful, the door-opening intention information is intending to open door, and the person's object carrying information is the person carrying an object of a predetermined type, it is possible to automatically open the tail gate for a person carrying an object of the present type, thereby facilitating placement of objects into the trunk.

As one example of this implementation, the determining the control information corresponding to at least one vehicle door of the vehicle based on the face recognition result, the door-opening intention information, and the person's object carrying information, comprising: determining that the control information includes controlling at least one non-driver side vehicle door of the vehicle to open if the face recognition result is face recognition successful and not a driver, the door-opening intention information is intending to open door, and the person's object carrying information is carrying an object. In this example, by determining that the control information includes controlling at least one non-driver side vehicle door of the vehicle to open if the face recognition result is face recognition successful and not a driver, the door-opening intention information is intending to open door, and the person's object carrying information is carrying an object, it is possible to automatically open a vehicle door corresponding to a suitable seat for a non-driver occupant.

In one possible implementation, the determining the control information corresponding to at least one vehicle door of the vehicle based on the face recognition result and the door-opening intention information may include: determining, based on the face recognition result and the door-opening intention information, control information corresponding to a vehicle door that corresponds to the image acquisition module acquiring the video stream. The vehicle door that corresponds to the image acquisition module acquiring the video stream may be determined according to the position of the image acquisition module. For example, if the video stream is acquired by an image acquisition module attached to the left B pillar and oriented to the front occupant boarding position, the vehicle door corresponding to the image acquisition module acquiring the video stream may be the left front door, thereby determining the control information corresponding to the left front door of the vehicle based on the face recognition result and the door-opening intention information. If the video stream is acquired by an image acquisition module attached to the left B pillar and oriented towards the rear occupant boarding position, the vehicle door corresponding to the image acquisition module acquiring the video stream may be the left rear door, thereby determining control information corresponding to the left rear door of the vehicle based on the face recognition result and the door-opening intention information. If the video stream is acquired by an image acquisition module attached to the right B pillar and oriented towards the front occupant boarding position, the vehicle door corresponding to the image acquisition module acquiring the video stream may be the right front door, thereby determining control information corresponding to the right front door based on the face recognition result and the door-opening intention information. If the video stream is acquired by an image acquisition module attached to right B pillar and oriented towards the rear occupant boarding position, the vehicle door corresponding to the image acquisition module acquiring the video stream may be the right rear door, thereby determining control information corresponding to the right rear door based on the face recognition result and the door-opening intention information. If the video stream is acquired by an image acquisition module attached to the tail gate, the vehicle door corresponding to the image acquisition module acquiring the video stream may be the tail gate, thereby control information corresponding to the tail gate of the vehicle based on the face recognition result and the door-opening intention information.

In step S14, obtaining, if the control information includes controlling any one vehicle door of the vehicle to open, state information of the vehicle door.

In the embodiment of the present disclosure, the state information of the vehicle door may be not unlocked, unlocked and unopened, and opened.

In step S15, controlling the vehicle door to unlock and open if the state information of the vehicle door is not unlocked; and/or controlling the vehicle door to open if the state information of the vehicle door is unlocked and unopened.

In the embodiment of the present disclosure, controlling the vehicle door to open may refer to controlling the vehicle door to pop open so that the user can enter the vehicle through the open vehicle door (e.g., a front door or a rear door) or place items through the open vehicle door (e.g., a tail gate or a rear door). By controlling the vehicle door to open, the needs for the user to manually pull open the vehicle door is eliminated when the vehicle door is unlocked.

In one possible implementation, the vehicle door is controlled to be unlocked and opened by transmitting an unlocking instruction and an opening instruction corresponding to the vehicle door to a vehicle door domain controller; the vehicle door is controlled to be opened by transmitting the opening instruction corresponding to the vehicle door to the vehicle door domain controller.

In an example, a System on Chip (SoC) of the vehicle door control apparatus may transmit a vehicle door unlocking instruction, a vehicle door-opening instruction, and a vehicle door closing instruction to the vehicle door domain controller, so as to control the vehicle door.

FIG. 5 illustrates another schematic diagram of a vehicle door control method provided by an embodiment of the present disclosure. In the example shown in FIG. 5, the video stream is acquired by the image acquisition module attached to the B pillar; face recognition result and door-opening intention information are obtained based on the video stream; and control information corresponding to at least one vehicle door of the vehicle is determined based on the face recognition result and the door-opening intention information.

In one possible implementation, the controlling an image acquisition module provided in a vehicle to acquire a video stream comprises: controlling an image acquisition module provided on a tail gate of the vehicle to acquire a video stream. In this implementation, the image acquisition module may be attached to the tail gate so that it is possible to detect an intention to place an object into the trunk or take an object out of the trunk based on the video stream acquired by the image acquisition module on the tail gate.

In one possible implementation, after the determining that the control information includes controlling the tail gate of the vehicle to open, the method further comprises: controlling the tail gate to open in a case where it is determined that the person leaves an indoor portion of the vehicle according to the video stream acquired by the image acquisition module provided in the indoor portion, or where it is detected that the door-opening intention information of the person is intending to disembark. According to this implementation, if an occupant places an object into the trunk before boarding, the tail gate automatically opens when the occupant disembarks, thereby eliminating the need of the occupant to manually pull open the tail gate as well as reminding the occupant to take away the object from the trunk.

In one possible implementation, after controlling the vehicle door to open, the method further comprises: controlling the vehicle door to close or controlling the vehicle door to close and be locked in a case where an automatic door closing condition is satisfied. In this implementation, by controlling the vehicle door to close or controlling the vehicle door to close and be locked in a case where an automatic door closing condition is satisfied, it is possible to improve the safety of the vehicle.

As one example of this implementation, the automatic door closing condition includes one or more of: where the door-opening intention information controlling the vehicle door to open is intending to board, and it is determined that the person intending to board has taken a seat according to the video stream acquired by the image acquisition module of the indoor portion of the vehicle; where the door-opening intention information for controlling the vehicle door-open is intending to disembark, and it is determined that the person intending to disembark has left the indoor portion according to the video stream acquired by the image acquisition module of the indoor portion of the vehicle; or where a time length during which the vehicle door is open reaches a second predetermined time length.

In an example, if the vehicle door over which the person has door-opening permission includes only the tail gate, it may be controlled such that the tail gate is controlled to close when the time length during which the tail gate is controlled to be open reaches the second predetermined time length. For example, the second predetermined time length may be 3 minutes. For example, the vehicle door over which a courier has door-opening permission includes the tail gate. In such case, controlling the tail gate to close when the time length during which the tail gate is controlled to be open reaches the second predetermined time length makes it possible to satisfy the needs for the courier to place a package into the trunk while improving the security of the vehicle.

In one possible implementation, the method further comprises either or both of: performing user registration according to a facial image acquired by the image acquisition module; performing remote registration according to a facial image acquired or uploaded by a first terminal and transmitting registration information to the vehicle, wherein the first terminal is a terminal corresponding to the owner, and the registration information includes the acquired or uploaded facial image.

In an example, performing owner registration according to a facial image acquired by the image acquisition module comprises: upon detecting that a registration button on a touch screen is clicked, requesting the user to input a password; when the password has been authenticated, initiating a RGB camera in the image acquisition module to acquire a facial image and performing registration according to the acquired facial image; extracting facial features in the facial image as pre-registered facial features; and performing face comparison in subsequent face authentication based on the pre-registered facial features.

In an example, the remote registration is performed according to the facial image acquired or updated by the first terminal; and registration information is transmitted to the vehicle, wherein the registration information includes the acquired or uploaded facial image. In this example, the user (e.g., the owner) may use a cellphone App (Application) to transmit to a Telematics Service Provider (TSP) cloud a registration request, wherein the registration request may carry the facial image acquired or uploaded by the first terminal. For example, the facial image acquired by the first terminal may be a facial image of the user (the owner); a facial image uploaded by the first terminal may be a facial image of the user (the owner), a friend of the user or a courier. The TSP cloud may transmit the registration request to an onboard Telematics Box (T-Box, a remote information processor) of the vehicle door control apparatus. The onboard T-Box may activate the face recognition function according to the registration request and use the facial features of the facial image carried by the registration request as the pre-registered facial features, so as to perform face comparison based on the pre-registered facial features in subsequent face authentication.

As one example of this implementation, the facial image uploaded by the first terminal includes a facial image transmitted by a second terminal to the first terminal, the second terminal being a terminal corresponding to a temporary user; the registration information further includes door-opening permission information corresponding to the uploaded facial image. For example, the temporary user may be a courier, and the like. In this example, the owner may set the door-opening permission information for the temporary user such as a courier.

In one possible implementation, the method further comprises: acquiring information about seat adjustment of an occupant; generating or updating seat preference information corresponding to the occupant according to the information about seat adjustment of the occupant. The seat preference information corresponding to the occupant may reflect preference information about seat adjustment of the occupant when using the vehicle. In this implementation, by generating or updating seat preference information corresponding to the occupant, it is possible to automatically perform seat adjustment according to the seat preference information corresponding to the occupant when the occupant uses the vehicle for a second time, so as to improve the travelling experience of the occupant.

In one possible implementation, the generating or updating seat preference information corresponding to the occupant according to the information about seat adjustment of the occupant comprises: generating or updating seat preference information corresponding to the occupant according to position information of a seat taken by the occupant and the information about seat adjustment of the occupant. In this implementation, the seat preference information corresponding to the occupant may be associated with not only the information about seat adjustment of the occupant, but also the position information of the seat taken by the occupant. That is, it is possible to record seat preference information of seats at different positions for the occupant, thereby further improving the travelling experience of the occupant.

In one possible implementation, the method further comprises: acquiring the seat preference information corresponding to the occupant based on the face recognition result; adjusting a seat taken by the occupant according to the seat preference information corresponding to the occupant. In this implementation, the seat may be automatically adjusted for the occupant according to the seat preference information of the occupant without manual adjustment by the occupant, thereby improving the driving or travelling experience of the occupant.

In an example, one or more of the height, the leg room, the back, the temperature etc. of the seat may be adjusted.

As one example of this implementation, the adjusting the seat taken by the occupant according to the seat preference information corresponding to the person comprises: determining position information of the seat taken by the occupant; adjusting the seat taken by the occupant according to the position information of the seat taken by the occupant and the seat preference information corresponding to the occupant. In this implementation, the seat can be automatically adjusted for the occupant according to the position information of the seat taken by the occupant and the seat preference information corresponding to the occupant without manual adjustment by the occupant, thereby improving the driving or travelling experience of the occupant.

In other possible implementation, it is further possible to acquire other personalized information corresponding to the occupant, such as light information, temperature information, air conditioning information, music information, etc. based on the face recognition result, and performing automatic setting according to the acquired personalized information.

In one possible implementation, before the controlling an image acquisition module provided in a vehicle to acquire a video stream, the method further comprises: searching for a Bluetooth device with a predetermined identification via a Bluetooth module provided on the vehicle; establishing a Bluetooth pairing connection between the Bluetooth module and the Bluetooth device with the predetermined identification in response to the Bluetooth device with the predetermined identification being found; waking up a face recognition module provided on the vehicle in response to the Bluetooth pairing connection being successful; the controlling an image acquisition module provided in a vehicle to acquire a video stream comprises: controlling, by the face recognition module that is woken up, the image acquisition module to acquire the video stream.

As one example of this implementation, the searching for a Bluetooth device with a predetermined identification via a Bluetooth module provided on the vehicle comprises: searching for a Bluetooth device with a predetermined identification via a Bluetooth module provided on the vehicle when the vehicle is in a shutdown state or a shutdown and door-locked state. In this example, before the vehicle is shut down, there is no need to search for a Bluetooth device with a predetermined identification using the Bluetooth module; or before the vehicle is shut down and in a state where the vehicle is shut down but the vehicle door is not in a locked state, there is no need to search for a Bluetooth device with a predetermined identification using the Bluetooth module, whereby power consumption is further reduced.

As one example of this implementation, the Bluetooth module may be a Bluetooth Low Energy (BLE) module. In this example, when the vehicle is in a shutdown state or a shutdown and door-locked state, the Bluetooth module may be in a broadcast mode and broadcasts a broadcast packet to a surrounding region at certain intervals (e.g., 100 milliseconds). If a Bluetooth device in the surrounding region receives the broadcast packet broadcasted by the Bluetooth module when performing a scanning action, it may transmit a scan request to the Bluetooth module, and the Bluetooth module may, in response to the scan request, return a scan response packet to the Bluetooth device that has transmitted the scan request. In this implementation, if a scan request is received from a Bluetooth device with a predetermined identification, it is determined that the Bluetooth device with a predetermined identification is found.

As another example of the implementation, when the vehicle is in a shutdown state or a shutdown and door-locked state, the Bluetooth module may be in a scanning state. If a Bluetooth device with a predetermined identification is scanned, it is determined that the Bluetooth device with a predetermined identification is found.

As one example of this implementation, the Bluetooth module and the face recognition module may be integrated into a face recognition system.

As another example of the implementation, the Bluetooth module may be independent from the face recognition system. That is, the Bluetooth module may be provided outside the face recognition system.

This implementation does not limit the maximum searching range of the Bluetooth module. In an example, the maximum searching range may be about 30 m.

In this implementation, the identification of the Bluetooth device may refer to a unique identifier of the Bluetooth device. For example, the identification of the Bluetooth device may be a ID, a name, or an address of the Bluetooth device, etc.

In this implementation, the predetermined identification may be an identification of a device that has been successfully paired with the Bluetooth module of the vehicle in advance based on a Bluetooth secure connection technology.

In this implementation, there may be one or more Bluetooth device with a predetermined identification. For example, if the identification of the Bluetooth device is an ID of a Bluetooth device, one or more Bluetooth ID may be preset to have permission to open the vehicle door. For example, in a case where there is one Bluetooth device with a predetermined identification, the Bluetooth device with a predetermined identification may be a Bluetooth device of the owner; in a case where there is a plurality of Bluetooth devices of a predetermined identification, the Bluetooth devices of the predetermined identification may include a Bluetooth device of the owner and Bluetooth devices of a family, a friend, and a pre-registered contact of the owner. The pre-registered contact may be a pre-registered courier or property management staff, etc.

In this implementation, the Bluetooth device may be any mobile device with Bluetooth capability. For example, the Bluetooth device may be a cellphone, a wearable device, or an electronic key, etc., wherein the wearable device may be a smart bracelet or smart glasses, etc.

As one example of this implementation, if there are a plurality of Bluetooth devices of a predetermined identification, establishing, in response to any one Bluetooth device with a predetermined identification being found, a Bluetooth pairing connection between the Bluetooth module and the Bluetooth device with a predetermined identification.

As one example of this implementation, in response to a Bluetooth device with a predetermined identification being found, the Bluetooth module performs an identification authentication on the Bluetooth device with the predetermined identification, and establishing the Bluetooth pairing connection between the Bluetooth module and the Bluetooth device with the predetermined identification after the identification authentication is successful.

In this implementation, when a Bluetooth pairing connection with a Bluetooth device with a predetermined identification is not established, the face recognition module may be in a sleep state to maintain a low-power operation, so as to reduce power consumption of the operation of opening the vehicle door by swiping a face; and the face recognition module would be in an operable state before a user carrying the Bluetooth device with the predetermined identification reaches the vehicle door; when the user carrying the Bluetooth device with the predetermined identification reaches the vehicle door, the image acquisition module is capable of rapidly performing facial image processing using the woken face recognition module after acquiring the first image, thereby improving the efficiency of face recognition and improving user experience. Therefore, the embodiment of the present disclosure meets not only the requirement of low-power operation but also the requirement of fast door-opening.

In this implementation, if a Bluetooth device with a predetermined identification is found, it largely indicates that a user carrying the Bluetooth device with a predetermined identification (e.g., the owner) is within the search range of the Bluetooth module. At this time, by establishing a Bluetooth pairing connection between the Bluetooth module and the Bluetooth device with the preset identification in response to the Bluetooth device with a predetermined identification being found and waking up the face recognition module in response to the Bluetooth pairing connection being successful, and controlling the image capture module to acquire the video stream, it is possible to effectively reduce the probability of mistakenly waking up the face recognition module in such a manner of waking up the face recognition module until the Bluetooth pairing connection is successful, thereby improving the user experience and effectively reducing the power consumption of face recognition module. Furthermore, compared with ultrasonic, infrared and other short-range sensor technologies, the Bluetooth-based pairing connection manner has the advantages of high security and supporting larger distances. It shows in practice that a time period for the user carrying the Bluetooth device with the predetermined identification to reach the vehicle through certain distance (the distance between the user and the vehicle when the Bluetooth pairing connection succeeds) may be roughly aligned with a time period for the vehicle to transform the face recognition module from the sleep state to the operation state to wake it up, so that the vehicle door may be opened by immediately performing face recognition by the woken face recognition module when the user reaches the vehicle door, without the user having to wait for the face recognition module to be woken up when arriving at the vehicle door, thereby improving the efficiency of a face recognition and improving a user experience. Furthermore, the user will not perceive a process of establishing Bluetooth pairing connection, which further improves user experience. Therefore, by waking up the face recognition module based on the Bluetooth pairing connection being successful, the implementation provides a solution balancing power saving of the face recognition module, the user experience and security.

In another possible implementation, the face recognition module is woken up in response to a user touching the face recognition module. According to this implementation, the user can still use the function of opening the vehicle door with facial recognition when the user forgets to bring the cellphone or other Bluetooth device.

In one possible implementation, after the waking up the face recognition module provided on the vehicle, the method further comprises: controlling the face recognition module to be in a sleep state if no facial image is acquired within a predetermined time. According to this implementation, when no facial image is acquired within a predetermined time after the face recognition module is woken up, the face recognition module is controlled to sleep, so as to reduce power consumption.

In one possible implementation, after the waking up the face recognition module provided on the vehicle, the method further comprises: controlling the face recognition module to be in a sleep state if face recognition does not succeed within a predetermined time. By controlling the face recognition module to be in a sleep state if face recognition does not succeed within a predetermined time after the face recognition module is woken up, this implementation may reduce power consumption.

In one possible implementation, after the waking up the face recognition module provided on the vehicle, the method further comprises: controlling the face recognition module to be in a sleep state in a case where a driving speed of the vehicle is not 0. In this implementation, by controlling the face recognition module to be in a sleep state in a case where a driving speed of the vehicle is not 0, it is possible to improve the security of opening the vehicle door-open with the face recognition and reduce power consumption.

In another possible implementation, before the controlling an image acquisition module provided in a vehicle to acquire a video stream, the method further comprises: searching for a Bluetooth device with a predetermined identification via the Bluetooth module provided on the vehicle; waking up the face recognition module provided on the vehicle in response to the Bluetooth device with a predetermined identification being found; the controlling an image acquisition module provided in a vehicle to acquire a video stream comprises: controlling, by the face recognition module that is woken up, the image acquisition module to acquire the video stream.

In one possible implementation, after obtaining a face recognition result, the method further comprises: activating a password unlocking module provided on the vehicle in response to the face recognition result being face recognition unsuccessful, to initiate a password unlocking process.

In this implementation, password unlocking is an alternative for face recognition unlocking. Reasons for failure of face recognition may include at least one of: the living body detection result is the person being a false body, face authentication fails, image acquisition fails (e.g., due to camera failure) and a number of times of recognition exceeds a predetermined number of times. When the person fails in the face recognition, the password unlocking process is initiated. For example, password input by the user may be acquired via the touch screen on the B pillar. In an example, after M times of continuously inputting a wrong password, password unlocking will be invalidated. For example, M may be 5.

In one possible implementation, the performing living body detection based on the first image and the first depth map comprises: updating the first depth map based on the first image to obtain a second depth map; determining a living body detection result based on the first image and the second depth map.

In this implementation, it is possible to update a depth value of one or more pixels in the first depth map based on the first image to obtain a second depth map.

In one possible implementation, the updating the first depth map based on the first image to obtain a second depth map comprises: updating a depth value of a depth invalid pixel in the first depth map based on the first image to obtain the second depth map.

The depth invalid pixel in the depth map may refer to a pixel included in the depth map of which the depth value is invalid, i.e., a pixel of which the depth value is incorrect or is apparently inconsistent with the actual condition. There may be one or more depth invalid pixel. By updating the depth value of at least one depth invalid pixel in the depth map, the depth values of the depth invalid pixels may be obtained more accurately, which contributes to improve the accuracy of living body detection.

In some embodiments, the first depth map may be a depth map with a missing value, the second depth map may be obtained by restoring the first depth map based on first image, wherein, optionally, restoring the first depth map includes determining or supplementing a depth value of a pixel having the missing value, but the embodiment of the present disclosure is not limited hereto.

In the embodiment of the present disclosure, the first depth map may be updated or restored in various manners. In some embodiments, the living body detection is performed directly using the first image. For example, the first depth map may be updated directly using the first image. In some other embodiments, the first image is pre-processed and the living body detection is performed based on the pre-processed first image. For example, the updating the first depth map based on the first image comprises: acquiring an image of the face from the first image; updating the first depth map based on the image of the face.

The image of the face may be extracted from the first image in various manners. As an example, face detection is performed on the first image to obtain position information of the face, such as position information of a bounding box of the face; and the image of the face is extracted from the first image based on the position information of the face. For example, an image of a region where a definition box of the face is located may be extracted from the first image as the image of the face. For a further example, the definition box of the face may be amplified by certain times, and an image of the region where the amplified definition box is located may be extracted from the first image as the image of the face. As another example, the acquiring the image of the face from the first image comprises: acquiring keypoint information of the face in the first image; and acquiring the image of the face from the first image based on the keypoint information of the face.

Optionally, the acquiring the keypoint information of the face in the first image comprises: performing face detection on the first image to determine a region where the face is located; and performing keypoint detection on an image of the region where the face is located to obtain the keypoint information of the face in the first image.

Optionally, the keypoint information of the face may include position information of a plurality of keypoints of the face. For example, the keypoints of the face may include one or more of an eye keypoint, an eyebrow keypoint, a nose keypoint, a mouth keypoint and a facial contour keypoint, wherein the eye keypoint may include one or more of an eye contour keypoint, an eye corner keypoint and a pupil keypoint.

In an example, a contour of the face may be determined based on the keypoint information of the face to extract the image of the face from the first image according to the contour of the face. Compared with the position information of the face obtained by the face detection, the position of the face obtained based on the keypoint information is more accurate, which facilitates an improvement of the accuracy of subsequent living body detection.

Optionally, it is possible to determine the contour of the face in the first image based on the keypoint of the face in the first image, and to determine an image of a region where the contour of the face in the first image is located or an image of a region obtained by amplifying the region of where the contour of the face in the first image is located by certain times as the image of the face. For example, an elliptical region determined based on the keypoints of the face in the first image may be determined as the image of the face, or the minimum rectangle enclosing the elliptical region determined based on the keypoints of the face in the first image may be determined as the image of the face, which is not limited by the embodiment of the present disclosure.

As such, by acquiring the image of the face from the first image and performing a living body detection based on the image of the face, it is possible to reduce interference of background information in the first image with the living body detection.

In the embodiment of the present disclosure, the obtained original depth map may be updated. Alternatively, in some embodiments, the updating the first depth map based on the first image to obtain a second depth map comprises: acquiring the depth map of the face from the first depth map; and updating the depth map of the face based on the first image to obtain the second depth map.

As an example, position information of the face is acquired from the first image to acquire the depth map of the face from the first depth map based on the position information of the face, wherein, optionally, the first depth map and the first image may be registered or aligned in advance, which is not limited in the embodiment of the present disclosure.

As such, by acquiring the depth map of the face from the first depth map and updating the depth map of the face based on the first image to obtain the second depth map, it is possible to reduce the interference of background information in the first depth map with the living body detection.

In some embodiments, after acquiring the first image and the first depth map corresponding to the first image, the first image and the first depth map are aligned according to parameters of the image sensor and parameters of the depth sensor.

As an example, the first depth map may be converted such that the converted first depth map is aligned with the first image. For example, a first conversion matrix may be determined according to the parameters of the depth sensor and the parameters of the image sensor to convert the first depth map according to the first conversion matrix. Accordingly, at least a portion of the converted first depth map may be updated based on at least a portion of the first image to obtain the second depth map. For example, the converted first depth map may be updated based on the first image to obtain a second depth map. For a further example, the depth map of the face extracted from the first depth map may be updated based on the image of the face extracted from the first image, to obtain a second depth map, and so on.

As another example, the first image may be converted such that the converted first image is aligned with the first depth map. For example, a second conversion matrix may be determined according to the parameters of the depth sensor and the parameters of the image sensor to convert the first image according to the second conversion matrix. Accordingly, at least a portion of the first depth map may be updated based on at least a portion of the converted first image to obtain a second depth map.

Optionally, the parameters of the depth sensor may include internal parameters and/or external parameters of the depth sensor; and the parameters of the image sensor may include internal parameters and/or external parameters of the image sensor. By aligning the first depth map with the first image, it is possible to ensure that the corresponding portions of both the first depth map and the first image have the same position in both the first depth map and the first image.

In the above example, the first image may be an original image (e.g., RGB or infrared image) while in some other embodiments, the first image may be an image of the face extracted from the original image. Similarly, the first depth map may alternatively be a depth map of the face extracted from an original depth map, which is not limited in the embodiment of the present disclosure.

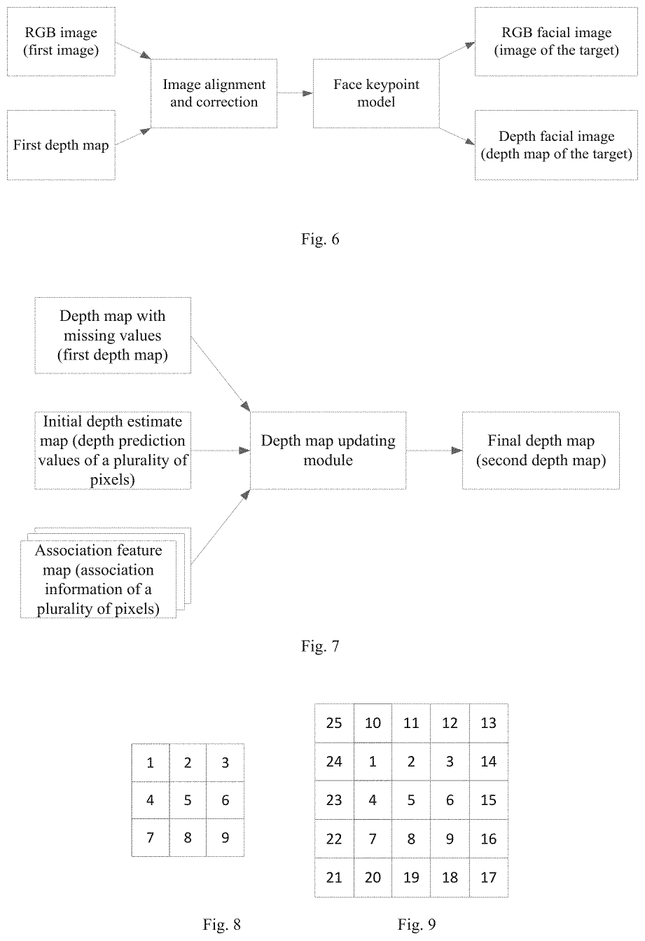

FIG. 6 illustrates a schematic diagram of an example of a living body detection method according to an embodiment of the present disclosure. In the example shown in FIG. 6, the first image may be an RGB image. The RGB image and the first depth map may be aligned and corrected to input them into a face keypoint model for processing, so as to obtain an RGB face map (an image of the face) and a depth face map (a depth map of the face), and update or restore the depth face map based on the RGB face map. As such, it is possible to reduce subsequent data processing amount and thus improve the efficiency and accuracy of the living body detection.

In the embodiment of the present disclosure, the living body detection result of the face may be the face being a living body or the face being a false body.

In some embodiments, the determining a living body detection result based on the first image and the second depth map may comprise: inputting the first image and the second depth map into a living body detection neural network for processing to obtain the living body detection result. Alternatively, other living body detection algorithms may be used to process the first image and the second depth map to obtain the living body detection result.

In some embodiments, the determining the living body detection result based on the first image and the second depth map may comprise: performing feature extraction on the first image to obtain first feature information; performing feature extraction on the second depth map to obtain second feature information; and determining a living body detection result based on the first feature information and the second feature information.

Optionally, the feature extraction may be implemented by a neural network or other machine learning algorithms, and the type of feature information extracted may optionally be obtained through sample learning, which is not limited in the embodiment of the present disclosure.

In some specific scenarios (e.g., an outdoor strong light scenario), the obtained depth map (e.g., the depth map acquired by a depth sensor) may have invalid partial areas. In addition, under normal illumination, the depth map may have random invalid partial areas due to reflection of glasses, black hair, black glass frame, and the like. Some special paper material may cause a printed face picture to produce an effect similar to a large invalid area or an invalid partial area of a depth map. In addition, the depth map may also be caused to be partially invalid by blocking the active light source of the depth sensor while the false body is normally imaged by the image sensor. Therefore, in some case where the depth map is partially or completely invalid, using the depth map to determine a living body or a false body will cause an error. In the embodiment of the present disclosure, by restoring or updating the first depth map and using the restored or updated depth map for the living body detection, it is possible to improve the accuracy of the living body detection.

In an example, the first image and the second depth map are input into the living body detection neural network to perform the living body detection, thereby obtaining a living body detection result of the face in the first image. The living body detection neural network may include two branches, i.e., a first sub-network and a second sub-network, where the first sub-network is configured to perform feature extraction on the first image to obtain the first feature information, and the second sub-network is configured to perform feature extraction on the second depth map to obtain the second feature information.

In an optional example, the first sub-network may include a convolution layer, a downsampling layer and a full connection layer. Alternatively, the first sub-network may include a convolution layer, a downsampling layer, a normalization layer and a full connection layer.

In an example, the living body detection neural network may further comprise a third sub-network configured to process the first feature information obtained by the first sub-network and the second feature information obtained by the second sub-network, to obtain a living body detection result of the face in the first image. Optionally, the third sub-network may include a full connection layer and an output layer. For example, the output layer may use a softmax function; if the output of the output layer is 1, it means that the face is a living body; if the output of the output layer is 0, it means that the face is a false body. The embodiment of the present disclosure does not limit the specific implementation of the third sub-network.

As an example, the determining the living body detection result based on the first feature information and the second feature information may comprises: performing fusion on the first feature information and the second feature information to obtain third feature information; and determining a living body detection result based on the third feature information.

For example, the third feature information may be obtained by performing fusion on the first feature information and the second feature information by a full connection layer.

In some embodiments, the determining the living body detection result based on the third feature information may comprise: acquiring a probability of the face being a living body based on the third feature information; and determining the living body detection result according to the probability of the face being a living body.

For example, if the probability of the face being the living body is greater than a second threshold value, it is determined that the living body detection result of the face is a living body. For a further example, if the probability of the face being a living body is smaller than or equal to the second threshold value, it is determined that the living body detection result of the face is a false body.

In some other embodiments, probability of the face being a false body is obtained based on third feature information; and a living body detection result of the face is determined according to the probability of the face being a false body. For example, if the probability of the face being a false body is greater than a third threshold value, it is determined that the living body detection result of the face is the face being a false body. For a further example, if the probability of the face being a false body is smaller than or equal to the third threshold value, it is determined that the living body detection result of the face is a living body.

In an example, the third feature information may be input into a Softmax layer; the probability of the face being a living body or a false body is obtained by the Softmax layer. For example, the output of the Softmax layer includes two nerve units, where one nerve unit represents the probability of the face being a living body, and the other nerve unit represents the probability of the face being a false body, but the embodiment of the present disclosure is not limited thereto.

In the embodiment of the present disclosure, by acquiring the first image and the first depth map corresponding to the first image, updating the first depth map based on first image to obtain the second depth map, and determining the living body detection result of the face in the first image based on the first image and the second depth map, it is possible to perfect the depth map, thereby improving the accuracy of living body detection.

In one possible implementation, the updating the first depth map based on the first image to obtain a second depth map may comprise: determining depth prediction value and association information of a plurality of pixels in the first image based on the first image, where the association information of the plurality of pixels indicates a correlation degree among the plurality of pixels; and updating the first depth map based on the depth prediction values and the association information of the plurality of pixels to obtain a second depth map.

Specifically, the depth prediction values of the plurality of pixels in the first image are determined based on the first image; and the first depth map is restored based on the depth prediction values of the plurality of pixels.

Specifically, the depth prediction values of the plurality of pixels in the first image may be obtained by processing the first image. For example, the first image may be input into a depth prediction network for processing to obtain depth prediction results of the plurality of pixels. For example, a depth prediction map corresponding to the first image is obtained, which is not limited in the embodiment of the present disclosure.

In some embodiments, the determining the depth prediction value of a plurality of pixels in the first image based on the first image may comprise: determining the depth prediction values of the plurality of pixels in the first image based on the first image and the first depth map.

As an example, the determining depth prediction values of a plurality of pixels in the first image based on the first image and the first depth map may comprise: inputting the first image and the first depth map into a depth prediction neural network for processing to obtain depth prediction values of the plurality of pixels in the first image. Alternatively, the first image and the first depth map may be processed by other methods to obtain the depth prediction value of a plurality of pixels, which is not limited in the embodiment of the present disclosure.

In an example, the first image and the first depth map may be input into a depth prediction neural network for processing to obtain an initial depth estimate map. The depth prediction values of a plurality of pixels in the first image can be determined based on the initial depth estimate map. For example, the pixel value of the initial depth estimate map may be the depth prediction value of a corresponding pixel in the first image.

The depth prediction neural network may be implemented by various network architectures. In an example, the depth prediction neural network includes an encoding portion and a decoding portion. Optionally, the encoding portion may include a convolution layer and a downsampling layer, and the decoding portion may include a deconvolution layer and/or an upsampling layer. Furthermore, the encoding portion and/or the decoding portion may further include a normalization layer. The specific implementation of the encoding portion and the decoding portion is not limited in the embodiment of the present disclosure. In the encoding portion, as the number of layers of networks increases, the resolution of the feature map reduces and the number of feature maps increases, thereby enabling acquisition of rich semantic features and image spatial features. In the decoding portion, the resolution of the feature map increases, and the resolution of the feature map eventually output by the decoding portion is the same as the resolution of the first depth map.

In some embodiments, the determining depth prediction values of a plurality of pixels in the first image based on the first image and the first depth map comprises: performing fusion on the first image and the first depth map to obtain a fusion result; and determining a depth prediction value of a plurality of pixels in the first image based on the fusion result.

In an example, the first image and the first depth map may be concated to obtain a fusion result.

In an example, a convolution processing is performed on the fusion result to obtain a second convolution result; a downsampling processing is performed based on the second convolution result to obtain a first encoding result; and the depth prediction values of a plurality of pixels in the first image are determined based on first encoding result.

For example, a convolution layer may be used to perform the convolution processing on the fusion result to obtain a second convolution result.

For example, the second convolution result is normalized to obtain a second normalization result; and the second normalization result is downsampled to obtain the first encoding result. Here, the normalization layer may be used to normalize the second convolution result to obtain the second normalization result; and a downsampling layer is used to downsample the second normalization result to obtain the first encoding result. Alternatively, the downsampling layer may be used to downsample the second convolution result to obtain the first encoding result.

For example, a deconvolution processing may be performed on the first encoding result to obtain a first deconvolution result; the first deconvolution result is normalized to obtain a depth prediction value. Here, a deconvolution layer may be used to perform the deconvolution processing on the first encoding result to obtain the first deconvolution result; the normalization layer may be used to normalize the first deconvolution result to obtain the depth prediction value. Alternatively, the deconvolution layer may be used to perform a deconvolution processing on the first encoding result to obtain the depth prediction value.

For example, the first encoding result is upsampled to obtain a first upsampling result; and the first upsampling result is normalized to obtain a depth prediction value. Here, an upsampling layer may be used to perform an upsampling processing on the first encoding result to obtain the first upsampling result; and the normalization layer may be used to normalized the first upsampling result to obtain the depth prediction value. Alternatively, the upsampling layer may be used to upsample the first encoding result to obtain the depth prediction value.

Furthermore, the first image is processed to obtain association information of a plurality of pixels in the first image, wherein the association information of a plurality of pixels in the first image may include a correlation degree between each pixel of the plurality of pixels in the first image and its surrounding pixels. The surrounding pixels of a pixel may include at least one adjacent pixel of the pixel, or include a plurality of pixels at a space of no more than a certain value from the pixel. For example, as shown in FIG. 8, the surrounding pixels of Pixel 5 includes Pixel 1, Pixel 2, Pixel 3, Pixel 4, Pixel 6, Pixel 7, Pixel 8 and Pixel 9 which are adjacent to Pixel 5. Accordingly, the association information of the plurality of pixels in the first image includes a correlation degree between Pixel 5 and the pixels including Pixel 1, Pixel 2, Pixel 3, Pixel 4, Pixel 6, Pixel 7, Pixel 8 and Pixel 9. As an example, the correlation degree between a first pixel and a second pixel can be measured using the association between the first pixel and the second pixel. The embodiment of the present disclosure may use a related technology to determine the association between pixels, which is not further described herein.

In the embodiment of the present disclosure, various methods may be used to determine the association information of a plurality of pixels. In some embodiments, the determining association information of a plurality of pixels in the first image based on the first image comprises: inputting the first image into a correlation degree detection neural network for processing to obtain the association information of a plurality of pixels in the first image. For example, an associated feature map corresponding to the first image is obtained. Alternatively, the association information of a plurality of pixels is obtained by other algorithms, which is not limited by the embodiment of the present disclosure.

In an example, the first image is input into the correlation degree detection neural network for processing to obtain a plurality of associated feature maps. It is possible to determine the association information of the plurality of pixels in the first image based on the plurality of associated feature maps. For example, “surrounding pixels” of a certain pixel refer to pixels having a distance equal to 0 from the certain pixel, i.e., the surrounding pixels of the certain pixel are pixels adjacent to the certain pixel, and thus the correlation degree detection neural network is capable of outputting 8 associated feature maps. For example, in a first associated feature map, a pixel value of a Pixel P_{i,j} is equal to a correlation degree between a Pixel P_{i-1, j-1} and the Pixel P_{i,j} in the first image, where P_{i,j} indicates a pixel in row i and column j; in the second associated feature map, the pixel value of Pixel P_{i,j} is equal to a correlation degree between a Pixel P_{i-1,j} and the Pixel P_{i,j} in the first image; in the third associated feature map, the pixel value of Pixel P_{i,j} is equal to a correlation degree between a Pixel P_{i-1,j+1} and the Pixel P_{i,j} in the first image; in the fourth associated feature map, the pixel value of the Pixel P_{i,j} is equal to a correlation degree between a Pixel P_{i,j-1} and the Pixel P_{i,j} in the first image; in the fifth associated feature map, the pixel value of the Pixel P_{i,j} is equal to a correlation degree between a Pixel P_{i,j+1} and the Pixel P_{i,j} in the first image; in the sixth associated feature map, the pixel value of the Pixel P_{i,j} is equal to a correlation degree between a Pixel P_{i+1,j-1} and the Pixel P_{i,j} in the first image; in the seventh associated feature map, the pixel value of the Pixel P_{i,j} is equal to a correlation degree between Pixel P_{i+1,j} and Pixel P_{i,j} in the first image; in the eighth associated feature map, the pixel value of the Pixel P_{i,j} is equal to a correlation degree between a Pixel P_{i+1,j}+1 and the Pixel P_{i,j} in the first image.

The correlation degree detection neural network may be implemented by various network structures. As an example, the correlation degree detection neural network may include an encoding portion and a decoding portion. The encoding portion may include a convolution layer and a downsampling layer, and the decoding portion may include a deconvolution layer and/or an upsampling layer. The encoding portion may further include a normalization layer. The decoding portion may also include a normalization layer. In the encoding portion, as the resolution of the feature map reduces, the number of feature maps increases, thereby enabling acquisition of rich semantic features and image spatial features. In the decoding portion, the resolution of the feature map increases, and the resolution of the feature map eventually output by the decoding portion is the same as the resolution of the first image. In the embodiment of the present disclosure, the association information may be an image or in the form of another data such as a matrix.

As an example, the inputting the first image into the correlation degree detection neural network for processing to obtain the association information of a plurality of pixels in the first image may include: performing a convolution processing on the first image to obtain a third convolution result; performing a downsampling processing based on the third convolution result to obtain a second encoding result; and obtaining the association information of a plurality of pixels in the first image based on the second encoding result.

In an example, the convolution layer may be used to perform the convolution processing on the first image to obtain the third convolution result.

In an example, performing the downsampling processing based on the third convolution result to obtain the second encoding result may include: performing a normalization processing on the third convolution result to obtain a third normalization result; performing a downsampling processing on the third normalization result to obtain the second encoding result. In this example, a normalization layer may be used to perform the normalization processing on the third convolution result to obtain the third normalization result; a downsampling layer may be used to perform the downsampling processing on the third normalization result to obtain the second encoding result. Alternatively, the downsampling layer may be used to perform a downsampling processing on the third convolution result to obtain the second encoding result.

In an example, determining the association information based on the second encoding result may include: performing a deconvolution processing on the second encoding result to obtain a second deconvolution result; and performing a normalization processing on the second deconvolution result to obtain the association information. In this example, a deconvolution layer may be used to perform the deconvolution processing on the second encoding result to obtain the second deconvolution result; a normalization layer may be used to perform a normalization processing on the second deconvolution result to obtain the association information. Alternatively, the deconvolution layer may be used to perform the deconvolution processing on the second encoding result to obtain the association information.

In an example, determining the association information based on the second encoding result may include: performing an upsampling processing on the second encoding result to obtain a second upsampling result; performing a normalization processing on the second upsampling result to obtain the association information. In the example, an upsampling layer may be used to perform the upsampling processing on the second encoding result to obtain the second upsampling result; and a normalization layer may be used to perform the normalization processing on the second upsampling result to obtain the association information. Alternatively, the upsampling layer may be used to perform the upsampling processing on the second encoding result to obtain the association information.

The existing 3D sensors such as TOF and structured light sensors are susceptible to sunlight outdoors, resulting in a depth map with a large area of missing voids, thus affecting the performance of the 3D living body detection algorithm. The embodiment of the present disclosure proposes a 3D living body detection algorithm based on depth map self-improvement which improves the performance of the 3D living body detection algorithm by restoring the depth map detected by the 3D sensor.

In some embodiments, after obtaining the depth prediction values and the association information of a plurality of pixels, the first depth map may be updated based on the depth prediction values and the association information of a plurality of pixels to obtain the second depth map. FIG. 7 illustrates an exemplary schematic diagram of updating of the depth map in a vehicle door control method provided by an embodiment of the present disclosure. In the example shown in FIG. 7, the first depth map is a depth map with missing values; the depth prediction values and the association information of a plurality of pixels which are obtained are an initial depth estimate map and an associated feature map, respectively. At this time, the depth map with missing values, the initial depth estimate map and the associated feature map are input to a depth map updating module (e.g., a depth updating neural network) for processing to obtain a final depth map, i.e., the second depth map.

In one possible implementation, the updating the first depth map based on the depth prediction values and the association information of the plurality of pixels to obtain a second depth map comprises: determining a depth invalid pixel in the first depth map; acquiring, from the depth prediction values of the plurality of pixels, a depth prediction value of the depth invalid pixel and depth prediction values of a plurality of surrounding pixels of the depth invalid pixel; acquiring, from the association information of the plurality of pixels, a correlation degree between the depth invalid pixel and the plurality of the surrounding pixels of the depth invalid pixel; determining an updated depth value of the depth invalid pixel based on the depth prediction value of the depth invalid pixel, the depth prediction values of a plurality of surrounding pixels of the depth invalid pixel, and the correlation degree between the depth invalid pixel and the surrounding pixels of the depth invalid pixel.

In the embodiment of the present disclosure, the depth invalid pixel in the depth map may be determined by various methods. As an example, a pixel in first depth map having a depth value of 0 may be determined as a depth invalid pixel; alternatively a pixel in the first depth map without a depth value may be determined as a depth invalid pixel.

In this example, for a portion of the first depth map having missing values which has a value (i.e., of which the depth value is not 0), its depth value is believed to be correct and credible; and this portion may be not updated and remain the original depth value. The depth value of pixels in the first depth map having a depth value of 0 may be updated.

As another example, the depth sensor may set the depth value of the depth invalid pixel to one or more predetermined values or within predetermined ranges. In the example, a pixel in the first depth map which has a depth value equal to a predetermined value or within a predetermined range may be identified as a depth invalid pixel.

According to the embodiment of the present disclosure, a depth invalid pixel in the first depth map may also be determined based on other statistical methods, which is not limited by the embodiment of the present disclosure.

In this implementation, the depth value of a pixel in the first image which is in the same position as the depth invalid pixel may be determined as the depth prediction value of the depth invalid pixel. Similarly, the depth value of a pixel in the first image which is in the same position as a surrounding pixel of the depth invalid pixel may be determined as the depth prediction value of a surrounding pixel of the depth invalid pixel.

As an example, the distance between the surrounding pixels of the depth invalid pixel and the depth invalid pixel may be less than or equal to a first threshold value.

FIG. 8 illustrates a schematic diagram of surrounding pixels in a vehicle door control method provided by an embodiment of the present disclosure. For example, where the first threshold value is 0, only neighboring pixels are used as the surrounding pixels. For example, the neighboring pixels of Pixel 5 may include Pixel 1, Pixel 2, Pixel 3, Pixel 4, Pixel 6, Pixel 7, Pixel 8 and Pixel 9, thus only Pixel 1, Pixel 2, Pixel 3, Pixel 4, Pixel 6, Pixel 7, Pixel 8, and Pixel 9 may be determined as the surrounding pixels of Pixel 5.

FIG. 9 illustrates another schematic diagram of surrounding pixels in a vehicle door control method provided by an embodiment of the present disclosure. For example, where the first threshold value is 1, in addition to the neighboring pixels, neighboring pixels of the neighboring pixels are also used as the surrounding pixels. That is, in addition to Pixel 1, Pixel 2, Pixel 3, Pixel 4, Pixel 6, Pixel 7, Pixel 8 and Pixel 9, Pixel 10 to Pixel 25 are also used as the surrounding pixels of Pixel 5.

As an example, the determining an updated depth value of the depth invalid pixel based on the depth prediction value of the depth invalid pixel, the depth prediction values of a plurality of surrounding pixels of the depth invalid pixel, and the correlation degree between the depth invalid pixel and the surrounding pixels of the depth invalid pixel comprises: determining a depth correlation value of the depth invalid pixel based on depth prediction values of the surrounding pixels of the depth invalid pixel and the correlation degree between the depth invalid pixel and a plurality of surrounding pixels of the depth invalid pixel; and determining the updated depth value of the depth invalid pixel based on the depth prediction value of the depth invalid pixel and the depth correlation value.

As another example, a significant depth value of the surrounding pixels with regard to the depth invalid pixel may be determined based on the depth prediction values of the surrounding pixels of the depth invalid pixel and the correlation degree between the depth invalid pixel and the surrounding pixels; and the updated depth value of the depth invalid pixel may be determined based on the significant depth value of each surrounding pixel of the depth invalid pixel with regard to the depth invalid pixel, and the depth prediction value of the depth invalid pixel. For example, a product of the depth prediction value of a certain surrounding pixel of the depth invalid pixel with the correlation degree corresponding to the surrounding pixel may be determined as the significant depth value of the surrounding pixel with regard to the depth invalid pixel, wherein the correlation degree corresponding to the surrounding pixel refers to the correlation degree between the surrounding pixel and the depth invalid pixel. For example, a product of a sum of significant depth values of each surrounding pixel of the depth invalid pixel with respect to the depth invalid pixel with a first predetermined coefficient can be determined to obtain a first product; a product of the depth prediction value of the depth invalid pixel with a second predetermined coefficient can be determined to obtain a second product; a sum of the first product and the second product may be determined as the updated depth value of the depth invalid pixel. In some embodiments, the sum of the first predetermined coefficient and the second predetermined coefficient may be 1.

In an example, the determining the depth correlation value of the depth invalid pixel based on depth prediction values of the surrounding pixels of the depth invalid pixel and the correlation degree between the depth invalid pixel and the plurality of surrounding pixels of the depth invalid pixel comprises: using the correlation degree between the depth invalid pixel and each surrounding pixel as a weight of the each surrounding pixel, calculating a weighted sum of depth prediction values of a plurality of surrounding pixels of the depth invalid pixel to obtain a depth correlation value of the depth invalid pixel. For example, where the Pixel depth invalid pixel, the depth correlation value of the depth invalid pixel 5 may be

$$\text{?}$$

$$\text{?} \text{indicates text missing or illegible when filed}$$

and the following Equation 1 may be used to determine the updated depth value F′₅ of the depth invalid pixel 5:

$${F}_{5}^{′} = {F}_{5} + {{\sum }_{1 \leq i \leq 9}^{ }}_{i \neq 5} \frac{{w}_{i}}{W} F , \qquad Equation 1$$

wherein

$$W = {{\sum }_{1 \leq i \leq 9}^{ }}_{i \neq 5} {w}_{i} ,$$

wᵢ indicates the correlation degree between Pixel i and the Pixel 5, Fᵢ indicates the depth prediction value of Pixel i.

In a further example, a product of the correlation degree between each of a plurality of surrounding pixels of the depth invalid pixel and the depth invalid pixel with the depth prediction value of each surrounding pixel may be determined; a maximum value of the product may be determined as the depth correlation value of the depth invalid pixel.

In an example, a sum of the depth prediction value of the depth invalid pixel and the depth correlation value may be determined as the updated depth value of the depth invalid pixel.

In a further example, a product of the depth prediction value of the depth invalid pixel with a third predetermined coefficient may be determined to obtain a third product; a product of the depth correlation value with a fourth predetermined coefficient may be determined to obtain a fourth product; a sum of the third product and the fourth product may be determined as the updated depth value of the depth invalid pixel. In some embodiments, a sum of the third predetermined coefficient and the fourth predetermined coefficient may be 1.

In some embodiments, a depth value of a non-depth invalid pixel in the second depth map is equal to the depth value of the non-depth invalid pixel in the first depth map.

In some other embodiments, the depth value of the non-depth invalid pixel may also be updated to obtain a more accurate second depth map, so as to further improve the accuracy of the living body detection.

It can be appreciated that the afore-described method embodiments mentioned in the present disclosure may be combined with one another to form combined embodiments without departing from the principle and the logic, which, due to limited space, will not be further described herein.

A person skilled in the art understands that in the afore-described method embodiments, the order or appearance of the steps does not imply a strict order of execution or thereby constitute any limitation to the process of implementation; the specific order of execution of the steps should be determined by their function and possible internal logic.

Furthermore, the present disclosure further provides a vehicle door control apparatus, an electronic device, a computer-readable storage medium, and a program, all applicable for realizing any one vehicle door control method provided by the present disclosure. The corresponding technical solution may refer to the description of the corresponding method, which will not be repeated herein.

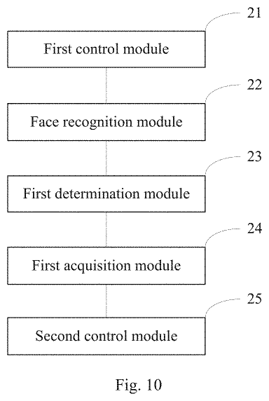

FIG. 10 illustrates a block diagram of a vehicle door control apparatus according to an embodiment of the present disclosure. As shown in FIG. 10, the vehicle door control apparatus comprises: a first control module 21 configured to control an image acquisition module provided in a vehicle to acquire a video stream; a face recognition module 22 configured to perform face recognition based on at least one image in the video stream to obtain a face recognition result; a first determination module 23 configured to determine, based on the face recognition result, control information corresponding to at least one vehicle door of the vehicle; a first acquisition module 24 configured to acquire, if the control information includes controlling any one vehicle door of the vehicle to open, state information of the vehicle door; a second control module 25 configured to control the vehicle door to unlock and open if the state information of the vehicle door is not unlocked; and/or control the vehicle door to open if the state information of the vehicle door is unlocked and unopened.

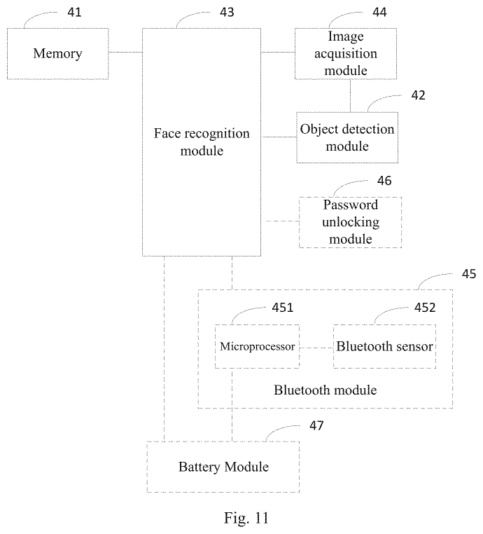

FIG. 11 illustrates a block diagram of the vehicle door control system provided by an embodiment of the present disclosure. As shown in FIG. 11, the vehicle door control system comprises: a memory 41, an object detection module 42, a face recognition module 43, and an image acquisition module 44. The face recognition module 43 is connected to the memory 41, the object detection module 42, and the image acquisition module 44, respectively. The object detection module 42 is connected to the image acquisition module 44. The face recognition module 43 is further provided with a communication interface configured to connect to a vehicle door domain controller. The face recognition module transmits, through the communication interface, control information configured to unlock and bounce open a vehicle door to the vehicle door domain controller.

In one possible implementation, the vehicle door control system further comprises: a Bluetooth module 45 connected to the face recognition module 43. The Bluetooth module 45 comprises a Bluetooth sensor 452 connected to a microprocessor 451, and the microprocessor 451 configured to wake up the face recognition module 43 upon Bluetooth pairing connection to a Bluetooth device with a predetermined identification being successful or upon the Bluetooth device with a predetermined identification being found.

In one possible implementation, the memory 41 may include at least one of a Flash memory and a Double Date Rate 3 (DDR3) memory.

In one possible implementation, the face recognition module 43 may be implemented by a System on Chip (SoC).

In one possible implementation, the face recognition module 43 is connected to the vehicle door domain controller via a Controller Area Network (CAN) bus.

In one possible implementation, the image acquisition module 44 comprises an image sensor and a depth sensor.

In one possible implementation, the depth sensor includes at least one of a binocular infrared sensor and a Time of Flight (TOF) sensor.

In one possible implementation, the depth sensor includes a binocular infrared sensor, and two infrared cameras of the binocular infrared sensor are arranged on two sides of a camera of the image sensor. For example, in the example shown in FIG. 3a, the image sensor is an RGB sensor; the camera of the image sensor is an RGB camera; the depth sensor is a binocular infrared sensor; the depth sensor includes two IR (infrared) cameras; and the two infrared cameras of the binocular infrared sensor are provided on two sides of the RGB camera of the image sensor.

In one possible implementation, the image acquisition module 44 further comprises at least one fill light. The at least one fill light is arranged between the infrared camera of the binocular infrared sensor and the camera of the image sensor. The at least one fill light includes at least one of a fill light for the image sensor and a fill light for a depth sensor. For example, if the image sensor is an RGB sensor, the fill light for the image sensor may be a white light; if the image sensor is an infrared sensor, the fill light for the image sensor may be an infrared light; and if the depth sensor is a binocular infrared sensor, the fill light for the depth sensor may be an infrared light. In the example shown in FIG. 3a, an infrared light is arranged between the infrared camera of the binocular infrared sensor and the camera of the image sensor. For example, the infrared light may use an infrared ray of 940 nm.

In an example, the fill light may be in a normally on mode. In this example, when the camera of the image acquisition module is in an operation state, the fill light is on.

In a further example, the fill light may be turned on when there is insufficient light. For example, an ambient light sensor may be used to acquire an ambient light intensity, determine insufficient light when the ambient light intensity is below a light intensity threshold, and turn on the fill light.

In one possible implementation, the image acquisition module 44 further comprises a laser. The laser is arranged between the camera of the depth sensor and the camera of the image sensor. For example, in the example shown by FIG. 3b, the image sensor is an RGB sensor; the camera of the image sensor is an RGB camera; the depth sensor is a TOF sensor; the laser is provided between the camera of the TOF sensor and the camera of the RGB sensor. For example, the laser may be a VCSEL; and the TOF sensor can be capable of acquiring a depth map based on a laser emitted by the VCSEL.

In an example, the depth sensor is connected to the face recognition module 43 via an LVDS (Low-Voltage Differential Signaling) interface.

In one possible implementation, the on-board face unlocking system further comprises: a password unlocking module 46 configured to unlock a vehicle door, the password unlocking module 46 being connected to the face recognition module 43.

In one possible implementation, the password unlocking module 46 includes either or both of a touch control screen and a keyboard.

In an example, the touch screen is connected to the face recognition module 43 via a Flat Panel Display Link (FPD-Link).

In one possible implementation, the on-board face unlocking system further comprises: a battery module 47. The battery module 47 is connected to the face recognition module 43. In an example, the battery module 47 is also connected to the microprocessor 451.

In one possible implementation, the memory 41, the face recognition module 43, the Bluetooth module 45 and the battery module 47 may be built on an Electronic Control Unit (ECU).

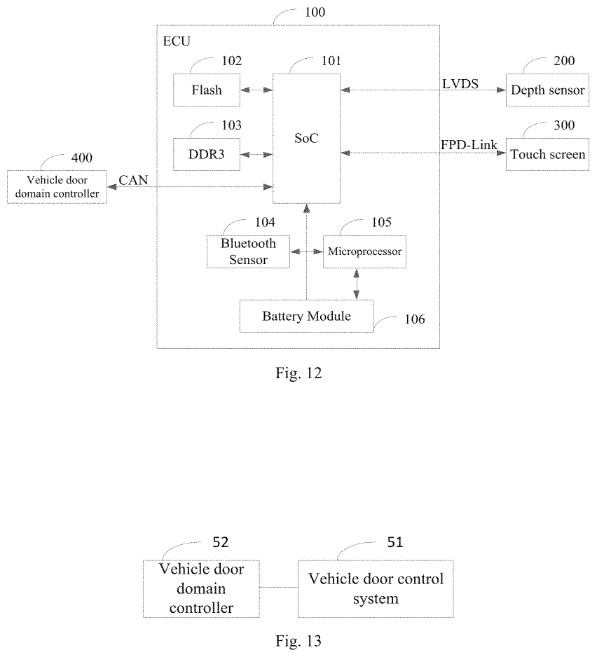

FIG. 12 illustrates a schematic diagram of a vehicle door control system according to an embodiment of the present disclosure. In the example shown in FIG. 12, a face recognition module is implemented by the SoC 101; a memory includes the Flash memory 102 and the DDR3 memory 103; a Bluetooth module includes the Bluetooth sensor 104 and the microprocessor (MCU, Microcontroller Unit) 105; the SoC 101, the Flash memory 102, the DDR3 memory 103, the Bluetooth sensor 104, the microprocessor 105 and the battery module 106 are built on the ECU100; the image acquisition module comprises a depth sensor 200; the depth sensor 200 is connected to the SoC 101 via the LVDS interface; the password unlocking module includes the touch control screen 300; the touch screen 300 is connected to the SoC 101 via the FPD-Link; the SoC 101 is connected to the vehicle door domain controller 400 via the CAN bus.

FIG. 13 illustrates a schematic diagram of a vehicle provided according to an embodiment of the present disclosure. As shown in FIG. 13, the vehicle comprises a vehicle door control system 51, the vehicle door control system 51 being connected to a vehicle door domain controller 52 of the vehicle.

The image acquisition module is provided on the outdoor portion of the vehicle; or the image acquisition module is disposed in at least one position of: B pillar of the vehicle, at least one vehicle door, at least one rear-view mirror; or the image acquisition module is provided on an indoor portion of the vehicle.

The face recognition module is provided inside the vehicle, and the face recognition module is connected to the vehicle door domain controller via a CAN bus.

The embodiment of the present disclosure further provides a computer-readable storage medium which stores computer program instructions which implements the method when executed by a processor, wherein the computer-readable storage medium may be a non-volatile computer-readable storage medium or a volatile computer-readable storage medium.

The embodiment of the present disclosure further provides a computer program comprising computer-readable codes. When the computer-readable codes run on an electronic apparatus, a processor in the electronic apparatus executes the above method.

The embodiment of the present disclosure further provides another computer program product configured to store computer-readable instructions which cause a computer to execute the vehicle door control method of any one of the afore-described embodiments when executed.

The embodiment of the present disclosure further provides an electronic device, comprising: one or more processor, a memory configured to store executable instructions, wherein the one or more processor is configured to call the executable instructions stored by the memory to execute the method.

The electronic device may be provided as a terminal, a server or a device taking other forms. The terminal may include, but not limited to, an on-board device, a mobile phone, a computer, a digital broadcasting terminal, a messaging device, a game console, a tablet device, medical equipment, fitness equipment, a personal digital assistant, and the like.

The present disclosure may be a system, a method, and/or a computer program product. The computer program product may include a computer readable storage medium having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may be specifically implemented by hardware, software, or a combination thereof. In an optional embodiment, the computer program product is specifically implemented as a computer storage medium. In another optional embodiment, the computer program product is specifically implemented as a software product, such as an Software Development Kit (SDK), etc.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A vehicle door control method, comprising:
controlling an image acquisition module provided in a vehicle to acquire a video stream;
performing face recognition based on at least one image in the video stream to obtain a face recognition result;
determining control information corresponding to at least one vehicle door of the vehicle based on the face recognition result;
acquiring, if the control information includes controlling any one vehicle door of the vehicle to open, state information of the vehicle door;
controlling the vehicle door to unlock and open if the state information of the vehicle door is not unlocked; and/or controlling the vehicle door to open if the state information of the vehicle door is unlocked and unopened.

2. The method according to claim 1, further comprising, before determining control information corresponding to at least one vehicle door of the vehicle based on the face recognition result:
determining door-opening intention information based on the video stream;
the determining control information corresponding to at least one vehicle door of the vehicle based on the face recognition result, comprising:
determining control information corresponding to at least one vehicle door of the vehicle based on the face recognition result and the door-opening intention information.

3. The method according to claim 2, the determining the door-opening intention information based on the video stream comprises:
determining an intersection-over-union of images of adjacent frames in the video stream;
determining the door-opening intention information based on the intersection-over-union of images of adjacent frames.

4. The method according to claim 3, wherein the determining the intersection-over-union of images of adjacent frames in the video stream comprises:
determining an intersection-over-union of bounding boxes of body in images of adjacent frames as the intersection-over-union of images of adjacent frames; and
wherein the determining the door-opening intention information based on the intersection-over-union of images of adjacent frames comprises:
caching an intersection-over-union of images of latest acquired N groups of adjacent frames, wherein N is an integer greater than 1;
determining a mean value of the cached intersection-over-union;
if a time period during which the mean value is greater than a first predetermined value reaches a first predetermined time length, the door-opening intention information is determined as intending to open door.

5. The method according to claim 2, wherein the determining the door-opening intention information based on the video stream comprises:
determining an area of a body region in latest acquired multi-frame images in the video stream;
determining the door-opening intention information according to the area of the body region in the latest acquired multi-frame images.

6. The method according to claim 5, wherein the determining the door-opening intention information according to the area of the body region in the latest acquired multi-frame images comprises at least one of:
if the area of the body region in all of the latest acquired multi-frame images is greater than a predetermined area, determining the door-opening intention information as intending to open door; or
if the area of the body region in the latest acquired multi-frame images increases gradually, determining the door-opening intention information as intending to open door.

7. The method according to claim 2, wherein the determining the control information corresponding to at least one vehicle door of the vehicle based on the face recognition result and the door-opening intention information comprises:
if the face recognition result is face recognition being successful, and the door-opening intention information is intending to open door, determining that the control information includes controlling at least one vehicle door of the vehicle to open.

8. The method according to claim 1, further comprising, before determining the control information corresponding to the at least one vehicle door of the vehicle based on the face recognition result:
performing object detection on at least one image of the video stream to determine a person's object carrying information;
the determining the control information corresponding to the at least one vehicle door of the vehicle based on the face recognition result comprising:
determining the control information corresponding to at least one vehicle door of the vehicle based on the face recognition result and the person's object carrying information.

9. The method according to claim 8, wherein the determining the control information corresponding to the at least one vehicle door of the vehicle based on the face recognition result and the person's object carrying information comprising:
if the face recognition result is face recognition being successful, and the person's object carrying information is the person carrying an object, determining that the control information includes controlling at least one vehicle door of the vehicle to open; or
if the face recognition result is face recognition being successful, and the person's object carrying information is the person carrying an object of a predetermined type, determining that the control information includes controlling a tail gate of the vehicle to open.

10. The method according to claim 2, further comprising, before determining the control information corresponding to the at least one vehicle door of the vehicle based on the face recognition result:
performing object detection on at least one image of the video stream to determine the person's object carrying information;
the determining the control information corresponding to the at least one vehicle door of the vehicle based on the face recognition result and the door-opening intention information comprising:
determining the control information corresponding to the at least one vehicle door of the vehicle based on the face recognition result, the door-opening intention information, and the person's object carrying information.

11. The method according to claim 10, wherein the determining the control information corresponding to the at least one vehicle door of the vehicle based on the face recognition result, the door-opening intention information and the person's object carrying information, comprising at least one of:
determining that the control information includes controlling the at least one vehicle door of the vehicle to open if the face recognition result is face recognition being successful, the door-opening intention information is intending to open door, and the person's object carrying information is the person carrying an object; or
determining that the control information includes controlling the tail gate of the vehicle to open if the face recognition result is face recognition being successful, the door-opening intention information is intending to open door, and the person's object carrying information is the person carrying an object of a predetermined type.

12. The method according to claim 8, wherein the performing object detection on at least one image of the video stream to determine the person's object carrying information comprises:
performing object detection on at least one image of the video stream to obtain an object detection result;
determining the person's object carrying information based on the object detection result.

13. The method according to claim 12, wherein the performing object detection on at least one image of the video stream to obtain the object detection result comprises:
detecting a bounding box of body in at least one image of the video stream;
performing object detection on a region corresponding to the bounding box to obtain the object detection result.

14. The method according to claim 12, wherein the determining the person's object carrying information based on the object detection result comprises:
if the object detection result is that an object is detected, obtaining a distance between an object and a hand of the person, and determining the person's object carrying information based on the distance; or
if the object detection result is that an object is detected, obtaining a distance between the object and the hand of the person and a dimension of the object, and determining the person's object carrying information based on the distance and the dimension; or
if the object detection result is that an object is detected, obtaining a dimension of the object, determining the person's object carrying information based on the dimension.

15. The method according to claim 14, wherein the determining the person's object carrying information based on the distance and the dimension comprises:
determining the person's object carrying information as the person carrying an object, if the distance is less than or equal to a predetermined distance and the dimension is greater than or equal to a predetermined dimension.

16. The method according to claim 14, wherein the controlling the image acquisition module provided in the vehicle to acquire the video stream comprises:
controlling the image acquisition module provided on a tail gate of the vehicle to acquire the video stream.

17. The method according to claim 15, further comprising, after the determining that the control information includes controlling the tail gate of the vehicle to open:
controlling the tail gate to open in a case where it is determined that the person leaves an indoor portion of the vehicle according to the video stream acquired by the image acquisition module provided in the indoor portion, or where it is detected that the door-opening intention information of the person is intending to disembark.

18. The method according to claim 10, wherein the determining the control information corresponding to the at least one vehicle door of the vehicle based on the face recognition result, the door-opening intention information, and the person's object carrying information comprising:
determining that the control information includes controlling at least one non-driver side vehicle door of the vehicle to open, if the face recognition result is face recognition being successful and not a driver, the door-opening intention information is intending to open door, and the person's object carrying information is carrying an object.

19. A vehicle door control apparatus, comprising:
a processor;
a memory configured to store processor-executable instructions;
wherein the processor is configured to execute instructions stored by the memory, so as to:
control an image acquisition module provided in a vehicle to acquire a video stream;
perform face recognition based on at least one image in the video stream to obtain a face recognition result;
determine control information corresponding to at least one vehicle door of the vehicle based on the face recognition result;
acquire, if the control information includes controlling any one vehicle door of the vehicle to open, state information of the vehicle door;
control the vehicle door to unlock and open if the state information of the vehicle door is not unlocked; and/or control the vehicle door to open if the state information of the vehicle door is unlocked and unopened.

20. A non-transitory computer-readable storage medium which stores computer program instructions, wherein when the computer program instructions are executed by a processor, the processor is caused to perform the operations of:
controlling an image acquisition module provided in a vehicle to acquire a video stream;
performing face recognition based on at least one image in the video stream to obtain a face recognition result;
determining control information corresponding to at least one vehicle door of the vehicle based on the face recognition result;
acquiring, if the control information includes controlling any one vehicle door of the vehicle to open, state information of the vehicle door;
controlling the vehicle door to unlock and open if the state information of the vehicle door is not unlocked; and/or controlling the vehicle door to open if the state information of the vehicle door is unlocked and unopened.
